(19) United States
(12) Patent Application Publication
(10) Pub. No.: US 2024/0276567 A1
(43) Pub. Date: Aug. 15, 2024

(54) APPLICATION FUNCTION NODE, USER EQUIPMENT, AND METHODS THEREFOR

(71) Applicant: NEC Corporation, Minato-ku, Tokyo (JP)

(72) Inventors: Tsuyoshi Takakura, Tokyo (JP); Toshiyuki Tamura, Tokyo (JP)

(73) Assignee: NEC Corporation, Minato-ku, Tokyo (JP)

(21) Appl. No.: 18/290,172

(22) PCT Filed: Mar. 31, 2022
(86) PCT No.: PCT/JP2022/016619

§ 371 Date: Nov. 10, 2023

(30) Foreign Application Priority Data
May 18, 2021 (JP) 2021-084222

(51) Int. Cl. H04W 76/11; H04W 92/24

(52) U.S. Cl. CPC H04W 76/11; H04W 92/24

(57) ABSTRACT

An Application Function (AF) (5) sends to a core network (3) a first message regarding an event related to a configuration of a user plane path for a PDU Session. If the AF (5) receives a second message based on an occurrence of the event from the core network (3) before a first predetermined period of time expires after transmitting the first message, the AF (5) sends a positive response to the second message to the core network (3). Otherwise, the AF (5) sends a third message to the core network (3) indicating a failure of a process in the AF (5) corresponding to the event. This allows, for example, the application function or the UE, or both, to deal with delays incurred in a procedure in the core network to change the user plane path in terms of runtime coordination between the core network and the application function.

### TECHNICAL FIELD

The present disclosure relates to a radio communication network, and in particular to the control of a user plane route (or path).

### BACKGROUND ART

The 5G system (5GS) connects a radio terminal (User Equipment (UE)) to a Data Network (DN). In the 5G architecture, connectivity services between the UE and the DN are supported by one or more Protocol Data Unit (PDU) Sessions (see, for example, Non-Patent Literature 1 and 2). A PDU Session is an association, session, or connection between the UE and the DN. A PDU Session is used to provide a PDU connectivity service (i.e., exchange of PDUs between the UE and the DN). A PDU Session is established between the UE and a User Plane Function (UPF) (i.e., PDU Session anchor) to which the DN is connected. From a data transfer perspective, a PDU Session consists of a tunnel (N9 tunnel) in the 5G Core Network (5GC), a tunnel (N3 tunnel) between the 5GC and an Access Network (AN), and one or more radio bearers.

Non-Patent Literature 1 (e.g., Section 5.6.7) and Non-Patent Literature 2 (e.g., Section 4.3.6) disclose Application Function (AF) influence on traffic routing. The AF influence on traffic routing is a control plane solution that enables an AF to provide input to the 5G Core Network (5GC) on how certain traffic should be routed. More specifically, the AF sends a request (hereafter referred to as an AF request) to the 5GC to influence the routing decisions made by a Session Management Function (SMF) regarding the traffic (i.e., one or more QoS Flows) of a Protocol Data Unit (PDU) session. The AF request triggers the SMF to change or select a User Plane (UP) path for the PDU Session. Changing (or selecting) the UP path involves changing or selecting a DN Access Identifier (DNAI). That is, the AF request affects the User Plane Function (UPF) selection by the SMF, allowing it to route user traffic to local access to the DN identified by the DNAI. The UPF selection or UP path modification by the SMF includes relocating (or reselecting) a PDU Session Anchor (PSA) UPF, adding a PSA UPF, and inserting a UL Classifier (ULCL) UPF or Branching Point (BP) UPF into the UP path.

The Application Function (AF) influence on traffic routing enables the AF to control whether traffic routing is enabled or disabled based on notifications (UP path management events) of whether a configuration change affecting traffic routing for a particular UE has occurred. In order to receive event notification when a routing configuration change occurs for traffic related to a particular UE, the AF sends an AF request to the SMF via a Network Exposure Function (NEF) by invoking the Nnef_EventExposure_Subscribe service operation. Traffic for a particular UE is specified by UE Identification Information, or UE Identification Information and Traffic Identification Information. The UE identification information may include, for example, a Subscription Permanent Identifier (SUPI), Generic Public Subscription Identifier (GPSI), Internal Group

Identifier, or External Group Identifier. The traffic identifier may include, for example, a Data Network Name (DNN). More specifically, the AF request can include a request for subscription to a notification about UP path management events. AF subscriptions may be for one or both Early notification and Late notification. For early notification subscriptions, the SMF sends notifications directly to the AF or via the NEF before a (new) UP path is configured. In the case of late notification subscriptions, the SMF sends notifications directly to the AF or via the NEF after a new UP path has been configured.

The Third Generation Partnership Project (3GPP) SA6 working group has begun standardization work on an architecture for enabling Edge Applications. (See, for example, Non-Patent Literature 3). This 3GPP architecture is called the EDGEAPP architecture. The EDGEAPP architecture provides a specification of an enabling layer to facilitate communication between application clients (ACs) running on a UE and applications deployed at the edge. According to the EDGEAPP architecture, edge applications provided by Edge Application Servers (EASs) are provided to ACs in a UE by an Edge Configuration Server (ECS) and an Edge Enabler Server (EES) through an Edge Enabler Client (EEC) of that UE.

The EDGEAPP architecture supports various Application Context Relocation (ACR) procedures for service continuity. The application context is the set of data present in an EAS and related to an AC. Application context relocation involves transferring the application context from a source EAS (or EDN) to a target EAS (or EDN). The ACR procedures are triggered by UE mobility events or non-UE mobility events. UE mobility events include, for example, intra-EDN mobility, inter-EDN mobility, and Local Area Data Network (LADN)-related mobility. Non-UE mobility events include, for example, EAS or EDN overload conditions and EAS maintenance (e.g., graceful shutdown of the EAS).

The AF sends an AF request to the Policy Control Function (PCF) directly or through the Network Exposure Function (NEF). The AF request can affect the routing decision made by the SMF for traffic of a PDU Session. In addition, the AF request can include a request for subscription to a notification about UP path management events. AF subscriptions may be for one or both Early notification and Late notification. For early notification subscriptions, the SMF sends notifications directly to the AF or via the NEF before a (new) UP path is configured. In the case of late notification subscriptions, the SMF sends notifications directly to the AF or via the NEF after a new UP path has been configured.

Non-Patent Literature 1 (e.g., Sections 5.6.7.1 and 5.6.7.2) and Non-Patent Literature 2 (e.g., Section 4.3.6.3) specify runtime coordination between the 5G Core Network (5GC) and an AF. This contributes to avoiding or minimizing service interruptions during PSA relocation (or addition) for a PDU Session in Session and Service Continuity (SSC) mode 3 or a PDU Session involving UL CL or BP. Specifically, an AF request for subscription to notification of UP path management events (e.g., DNAI change) may optionally include an indication of “AF acknowledgment to be expected”. This indication implies that the AF intends to provide the 5GC with a response to the notification of the UP path management event. According to this indication, the SMF waits for a response from the AF before the SMF configures a new UP path in the case of early notification. In the case of a late notification, according to this indication, the SMF waits for a response from the AF before the SMF activates the new UP path.

The AF may confirm a UP path management event (e.g., DNAI change) indicated in a notification by sending a positive response to the notification to the SMF. Alternatively, the AF may reject the UP path management event (e.g., DNAI change) indicated in the notification by sending a negative response to the SMF. The AF can determine if application relocation is necessary according to the notification of the DNAI change. The AF sends a positive response after the application relocation is completed. Alternatively, if the AF determines that the application relocation cannot be completed on time (e.g., due to temporary congestion), the AF sends a negative response.

In the case of early notification, based on the indication of “AF acknowledgment to be expected”, the SMF does not configure the UP path to the new DNAI until it receives a positive AF response. In the case of late notification, based on the indication of “AF acknowledgment to be expected”, the SMF does not activate the UP path to the new DNAI until it receives a positive AF response. Before the UP path to the new DNAI is activated, the application traffic data (if any) is still routed to the old DNAI. After the UP path to the new DNAI is activated, the data is routed to the new DNAI. If the SMF receives a negative response at any time, it can continue to use the original DNAI and cancel the associated PSA relocation or addition. The SMF can afterwards perform a DNAI reselection if necessary.

### CITATION LIST

### Non Patent Literature

[Non-Patent Literature 1] 3GPP TS 23.501 V17.0.0 (2021-03) “3rd Generation Partnership Project; Technical Specification Group Services and System Aspects; System Architecture for the 5G System (5GS); Stage 2 (Release 17)”, March 2021

[Non-Patent Literature 2] 3GPP TS 23.502 V17.0.0 (2021-03) “3rd Generation Partnership Project; Technical Specification Group Services and System Aspects; Procedures for the 5G System (5GS); Stage 2 (Release 17)”, March 2021

[Non-Patent Literature 3] 3GPP TS 23.558 V2.0.0 (2021-03) “3rd Generation Partnership Project; Technical Specification Group Services and System Aspects; Architecture for enabling Edge Applications; (Release 17)”, March 2021

### SUMMARY OF INVENTION

### Technical Problem

As described above, the EDGEAPP architecture supports various ACR procedures for service continuity. In addition, as mentioned above, runtime coordination between 5GC and AF is specified in the 3GPP specification. As mentioned above, the AF can reject a UP path management event (e.g., DNAI change) indicated in a notification by sending a negative response to the notification to the SMF. For example, if the AF determines that the application relocation cannot be completed on time (e.g., due to temporary congestion), the AF sends a negative response. It could be understood from these 3GPP specification provisions that the AF will send a negative response to the 3GPP core network (e.g., SMF) if delays have occurred or are anticipated in the process or procedure of application context relocation in the AF or EDN. This allows the AF to reject a UP path management event (e.g., DNAI change).

However, while the process or procedure related to the relocation of the application context in the AF or EDN can be completed successfully, the procedure in the 3GPP core network to configure (or change) the UP path for the PDU Session (e.g., UPF relocation or addition) may be delayed for some reason. For example, if the relocation of the application context from the source EAS to the target EAS is completed, but the UP path to access the target EAS is not configured or activated in a timely manner, the AC running on the UE and the target EAS may not be able to continue their application layer communications properly. The current provision in the 3GPP specification may not adequately address this issue. In particular, it is not clear how the AF should operate if the procedure within the 3GPP core network to configure (or change) the UP path for a PDU Session (e.g., UPF relocation or addition) is delayed for some reason. It is also not clear how the AF will detect that a procedure within the 3GPP core network is delayed.

One of the objects to be achieved by example embodiments disclosed herein is to provide apparatuses, methods, and programs that enable an application function or a UE or both to cope with delays incurred in a procedure in the core network to configure (or modify) a user plane path with respect to runtime coordination between the core network and the application function. It should be noted that this object is merely one of the objects to be achieved by the example embodiments disclosed herein. Other objects or problems and novel features will be become apparent from the following description and the accompanying drawings.

### Solution to Problem

In a first aspect, an AF node includes a memory and at least one processor coupled to the memory. The at least one processor is configured to send to a core network a first message regarding an event related to a configuration of a user plane path for a PDU Session. The at least one processor is configured to, if the AF node receives a second message based on an occurrence of the event from the core network before a first predetermined period of time expires after the transmission of the first message, send a positive response to the second message to the core network. Further, the at least one processor is configured to, if the AF node does not receive the second message from the core network before the expiration of the first predetermined period of time, send to the core network a third message indicating a failure of a process in the AF node corresponding to the event.

In a second aspect, a method performed by an AF node includes the following steps:
(a) sending to a core network a first message regarding an event related to a configuration of a user plane path for a PDU Session;
(b) if the AF node receives a second message based on an occurrence of the event from the core network before a first predetermined period of time expires after the transmission of the first message, sending a positive response to the second message to the core network; and
(c) if the AF node does not receive the second message from the core network before the expiration of the first predetermined period of time, sending to the core network a third message indicating a failure of a process in the AF node corresponding to the event.

In a third aspect, a UE includes a memory and at least one processor coupled to the memory. The at least one processor is configured to provide Edge Enabler Client (EEC) functionality. The at least one processor is configured to receive, from a Source Edge Enabler Server (S-EES), an indication of a failure of an Application Context Relocation (ACR) procedure involving transfer of an application context from a Source Edge Application Server (S-EAS) to a Target EAS (T-EAS). Further, the at least one processor is configured to, if a profile of the S-EAS has been invalidated, activate the profile of the S-EAS in response to receiving the indication. The failure of the ACR procedure is due to a delay in configuring a user plane path for a PDU Session.

In a fourth aspect, a method performed by an AF node includes the following steps:
(a) providing EEC functionality;
(b) receiving, from an S-EES, an indication of a failure of an ACR procedure involving transfer of an application context from an S-EAS) to a T-EAS; and
(c) if a profile of the S-EAS has been invalidated, activating the profile of the S-EAS in response to receiving the indication, wherein the failure of the ACR procedure is due to a delay in configuring a user plane path for a Protocol Data Unit (PDU) Session.

In a fifth aspect, a program includes instructions (software codes) that, when loaded into a computer, cause the computer to perform the method according to the above-described second or fourth aspect.

### Advantageous Effects of Invention

According to the above-described aspects, it is possible to provide apparatuses, methods, and programs that enable an application function or a UE or both to cope with delays incurred in a procedure in the core network to configure (or modify) a user plane path with respect to runtime coordination between the core network and the application function.

### BRIEF DESCRIPTION OF DRAWINGS

FIG. 1 shows a configuration example of a radio communication network according to an embodiment;

FIG. 2 shows an example of a deployment model for EDNs according to an example embodiment;

FIG. 3 shows an example of a deployment model for EDNs according to an example embodiment;

FIG. 4 shows an example of a deployment model for EDNs according to an example embodiment;

FIG. 5 shows an example of the 3GPP EDGEAPP architecture according to an example embodiment;

FIG. 6 is a flowchart showing an example of the operation of an AF according to an example embodiment;

FIG. 7 is a sequence diagram showing an example of the operation of an AF and related NFs according to an example embodiment;

FIG. 8 is a sequence diagram showing an example of the operation of an AF and related NFs according to an example embodiment;

FIG. 9 is a sequence diagram showing an example of the operation of an AF and related NFs according to an example embodiment;

FIG. 10 is a sequence diagram showing an example of the operation of an AF and related NFs according to an example embodiment;

FIG. 11 is a sequence diagram showing an example of the operation of an AF and related NFs according to an example embodiment;

FIG. 12 is a sequence diagram showing an example of the operation of an AF and related NFs according to an example embodiment;

FIG. 13 is a sequence diagram showing an example of the operation of an AF and related NFs according to an example embodiment;

FIG. 14 is a sequence diagram showing an example of the operation of an EEC and an EES according to an example embodiment; FIG. 15 is a sequence diagram showing an example of the operation of an EEC, an EES, and an EAS according to an example embodiment;

FIG. 16 is a block diagram showing an example configuration of a UE according to an example embodiment; and

FIG. 17 is a block diagram showing an example configuration of an AF, an EAS, and EAS according to an example embodiment.

### EXAMPLE EMBODIMENT

Specific example embodiments will be described hereinafter in detail with reference to the drawings. The same or corresponding elements are denoted by the same symbols throughout the drawings, and duplicated explanations are omitted as necessary for the sake of clarity.

Each of the example embodiments described below may be used individually, or two or more of the example embodiments may be appropriately combined with one another. These example embodiments include novel features different from each other. Accordingly, these example embodiments contribute to attaining objects or solving problems different from one another and contribute to obtaining advantages different from one another.

The example embodiments presented below are described primarily for the 3GPP system (e.g., 5G system (5GS)). However, these example embodiments may be applied to other radio communication systems.

As used in this specification, “if” may be interpreted as meaning “when”, “at or around the time”, “after”, “upon”, “in response to determining”, “in accordance with a determination”, or “in response to detecting”, depending on the context.

### First Example Embodiment

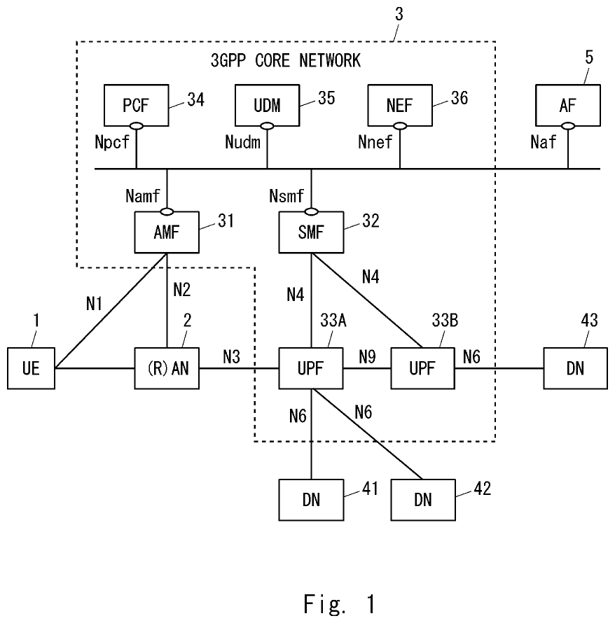

FIG. 1 shows an example configuration of a radio communication network (i.e., 5GS) according to this example embodiment. The elements shown in FIG. 1 are network functions and provides interfaces as defined by the 3GPP. Each of the elements (network functions) shown in FIG. 1 can be implemented, for example, as a network element on dedicated hardware, as a software instance running on dedicated hardware, or as a virtual function instantiated on an application platform.

The radio communication network shown in FIG. 1 may be provided by a Mobile Network Operator (MNO), or it may be a Non-Public Network (NPN) provided by a non-MNO. If the radio communication network shown in FIG. 1 is an NPN, it may be an independent network, represented as a Stand-alone Non-Public Network (SNPN), or it may be an NPN connected to an MNO network, represented as a public network integrated NPN.

A radio terminal (i.e., UE) 1 communicates with a data network (DN) using 3GPP (e.g., 5G) connectivity services. More specifically, the UE 1 is connected to a (radio) access network (e.g., 5G Access Network (5GAN)) 2 and communicates with a DN via one or more User

Plane Functions (UPFs) 33 (e.g., UPF 33A and UPF 33B) in a 3GPP core network 3 (e.g., 5G core network (5GC)). The 3GPP core network 3 may be, for example, but not limited to, 5GC. The 3GPP core network 3 may include networks other than 5G (e.g., future 6G or non-3GPP).

The UE 1 can communicate with multiple DNs simultaneously. As an example, FIG. 1 shows three DNs, namely DN 41, DN 42, and DN 43. The UE 1 may communicate with one or more of the DN 41, DN 42, and DN 43 simultaneously. At least two of the DN 41, DN 42, and 43 may be the same DN. For example, the DN 41, DN 42, and DN 43 may be the same DN and may be distinguished from each other by different DN Access Identifiers (DNAIs). At least one of the DN 41 and DN 42 may be a Local Area Data Network (LADN). For example, the DN 41 and DN 42 may be different LADNs from each other. If the DN 41 corresponds to one LADN, the UE 1 is allowed to access the DN 41 via a PDU Session for the DN 41 only when the UE 1 is in the LADN service area of the DN 41. A LADN Service Area is a set of one or more Tracking Areas (TAs) belonging to the current registration area of a UE. The DN 41 and DN 42 may be the same LADN and distinguished by different DNAIs. Alternatively, the DN 41 and DN 42 may be the same LADN and distinguished by different DNAIs.

In the 3GPP system architecture for 5G and beyond, connectivity services between the UE 1 and one DN are supported by one or more Protocol Data Unit (PDU) Sessions. A PDU Session is an association, session, or connection between the UE 1 and the DN. A PDU Session is used to provide a PDU connectivity service (i.e., exchange of PDUs between the UE 1 and the DN). The UE 1 establishes one or more PDU Sessions between the UE 1 and a UPF 33 (i.e., PDU Session anchor) to which the DN is connected. From a data transfer perspective, a PDU Session consists of a tunnel within the 3GPP core network 3 (N9 tunnel), a tunnel between the 3GPP core network 3 and the AN 2 (N3 tunnel), and one or more radio bearers between the UE 1 and the AN 2.

Although not shown in FIG. 1, the UE 1 may establish multiple PDU Sessions with multiple (PSA) UPFs 33 in order to simultaneously (or concurrently) access (sub)networks (or entities) (e.g., DN 41 and DN 43) indicated by multiple DNs or multiple DNAIs. One PDU Session may be split to access (sub)networks (or entities) (e.g., DN 41 and DN 43) indicated by multiple DNAIs of a single DN. Specifically, one PDU Session may be split at a UPF 33A if the DN 41 and DN 43 are the same DN and are differentiated by different DNAIs. In this case, the UPF 33A provides the UL CL or BP function, and also provides the PSA function for traffic associated with DN (or DNAI) 41. The UPF 33A may forward some of the uplink traffic of the PDU Session to the DN (DNAI) 41 and the rest of the uplink traffic of the PDU Session to a UPF 33B. In addition, the UPF 33A may merge all downlink traffic of the PDU Session into the N3 tunnel between the UPF 33A and the AN 2.

An Access and Mobility management Function (AMF) 31 is one of the network function nodes in the control plane of the 3GPP core network 3. The AMF 31 provides termination for a RAN Control Plane (CP) interface (i.e., N2 interface). The AMF 31 terminates a single signalling connection (i.e., N1 NAS signalling connection) with the UE 1 and provides registration management, connection management, and mobility management. The AMF 31 provides NF services to NF consumers (e.g., other AMFs, and SMF 32) via a service-based interface (i.e., Namf interface). The NF services provided by the AMF 31 include a communication service (Namf_Communication). This communication service allows NF consumers (e.g., SMF 32) to communicate with the UE 1 or the AN 2 via the AMF 31.

A Session Management Function (SMF) 32 is one of the network function nodes in the control plane of the 3GPP core network 3. The SMF 32 manages PDU Sessions. The SMF 32 sends and receives SM signaling messages (NAS-SM messages, N1 SM messages) to and from the Non-Access-Stratum (NAS) Session Management (SM) layer of the UE 1 via the communication service provided by the AMF 31. The SMF 32 provides Network Function (NF) services to NF consumers (e.g., AMF 31, other SMFs, and NEF 36) via a service-based interface (i.e., Nsmf interface). The NF services provided by the SMF 32 include a PDU Session management service (Nsmf_PDUSession). This NF Service allows NF consumers (e.g., AMF 31) to handle PDU Sessions. The NF service provided by the SMF 32 further includes an Event Notification service (Nsmf_EventExposure). The service operations exposed by this NF service allow NF consumers (e.g., NEF 36, AF 5) to get notified of events that occur in PDU Sessions.

The User Plane Function (UPF) 33 is one of the network function nodes in the user plane of the 3GPP core network 3. The UPF 33 processes and forwards user data. The functionality of the UPF 33 is controlled by the SMF 32. The UPF 33 may include multiple UPFs (e.g., UPF 33A and UPF 33B shown in FIG. 1) interconnected via the N9 interface. As already described, the UP path for one PDU Session of the UE 1 may include one or more PSA UPFs, may include one or more Intermediate UPFs (I-UPFs), and may include one or more UL CL UPFs (or BP UPFs).

A Policy Control Function (PCF) 34 is one of the network function nodes in the control plane of the 3GPP core network 3. The

PCF 34 supports interactions with the access and mobility policy enforcement within the AMF 31 via a service-based interface (i.e., Npcf interface). The PCF 34 provides access and mobility management-related policies to the AMF 31. In addition, the PCF 34 provides session-related policies to the SMF 32. The session-related policies include PDU Session-related policy information and Policy and Charging Control (PCC) rule information. The PCC rule information includes control information regarding AF influence on traffic routing (i.e., AF influenced Traffic Steering Enforcement Control information).

A Unified Data Management (UDM) 35 is one of the network function nodes in the control plane of the 3GPP core network 3. The UDM 35 provides access to a database (i.e., User Data Repository (UDR)) storing subscriber data (or subscription information). The UDM 35 provides NF services to NF consumers (e.g., AMF 31, SMF 32) via a service-based interface (i.e., Nudm interface). The NF services provided by the UDM 35 include a subscriber data management service. This NF service allows NF consumers (e.g., AMF 31, PCF 34) to retrieve subscriber data and provides updated subscriber data to the NF consumers. From a subscriber data management perspective, the UDM 35 can be represented as a UDR. Similarly, a UDR may be represented as a UDM 35.

A Network Exposure Function (NEF) 36 is one of the network function nodes in the control plane of the 3GPP core network 3. The NEF 36 has a role similar to that of a Service Capability Exposure Function (SCEF) in the Evolved Packet System (EPS). Specifically, the NEF 36 supports the exposure of services and capabilities from the 3GPP system to applications and network functions inside and outside the operator network. The NEF 36 provides NF services to NF consumers (e.g., AF 5) via a service-based interface (i.e., Nnef interface). The NF services provided by the NEF 36 include an event notification service (Nnef_EventExposure). The service operations exposed by this NF service allow NF consumers (e.g., AF 5) to get notified of events occurring in the 3GPP system. The NF services provided by the NEF 36 also include a service for Application Function influence on traffic routing (Nnef_TrafficInfluence). The service operations exposed by this NF service allow NF consumers (e.g., AF 5) to make requests to influence the traffic routing of PDU Session(s) of a particular UE.

An Application Function (AF) 5 interacts with the 3GPP core network 3. For example, the AF 5 interacts with the 3GPP core network 3 to support the Application Function influence on traffic routing. Depending on the placement of the AF 5 and the policy of the MNO, the AF 5 may interact directly with network functions within the 3GPP core network 3. Otherwise, the AF 5 interacts with network functions within the 3GPP core network 3 via the NEF 36. The AF 5 may include one or more computers. For example, the AF 5 may include one or more servers (e.g., content delivery servers, online game servers) that communicate with the UE 1 at the application layer, and a controller (i.e., an AF according to the 3GPP definition) that interfaces with these one or more servers and interacts with the 3GPP core network 3 (e.g., NEF 36, and SMF 32). The AF 5 may include multiple servers that are deployed in a distributed manner. For example, the AF 5 may include multiple edge computing servers located at (or connected to) the DN 41 and DN 42, in addition to a central server located at (or connected to) the DN 43. In the example in FIG. 1, the AF 5 may communicate with an application running on the processor of the UE 1 through at least one of the DN 41, DN 42, and DN 43.

The example configuration in FIG. 1 shows only representative NFs for illustration purposes. The radio communication network according to this embodiment may include other NFs not shown in FIG. 1, such as a Network Slice Selection Function (NSSF) and a Network Data Analysis Function (NWDAF).

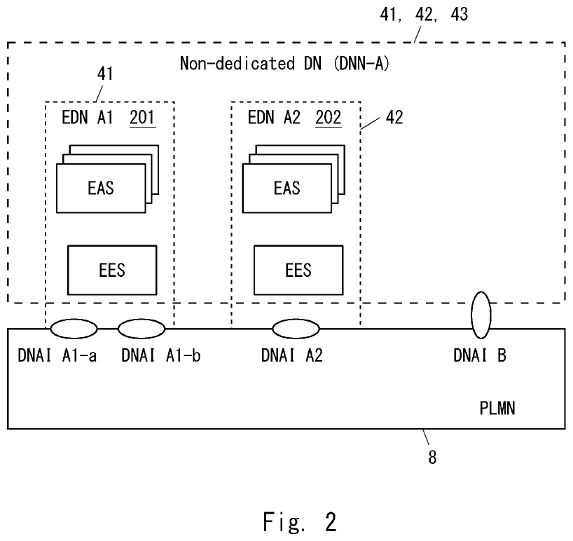

FIGS. 2, 3, and 4 show several examples of deployment models for Edge Data Networks (EDNs). A Public Land Mobile Network (PLMN) 8 includes the AN 2 and the 3GPP core network 3.

In the example in FIG. 2, a non-dedicated DN is used. That is, one DN (DNN-A) that is shared with other services (e.g., Internet access) is used to connect to Edge Application Servers (EASs). The one DN identified by DNN-A shown in FIG. 2 corresponds to the DN 41, DN 42, and DN 43 shown in FIG. 1. In other words, in the example in FIG. 2, the DN 41, DN 42, and DN 43 are the same DN and are distinguished by different DNAIs (e.g., DNAI A1-a, DNAI A1-b, DNAI A2, and DNAI B). One EDN is identified by a Data Network Name (DNN) and one or more DNAIs. For example, the DN 41 may contain an EDN A1 (201) and may be identified by DNN-A and DNAI A1-a and DNAI A1-b. The DN 42 may contain an EDN A2 (202) and may be identified by DNN-A and DNAI A2. The DN 43 may correspond to a centralized DN and may be identified by DNN-A and DNAI B. Each EAS and Edge Enabler Server (EES) can have a Topological Service Area or a Geographic Service Area. Within this service area, the UE 1 can access the EAS or EES via local breakout, regardless of the UE 1's location within the PLMN area.

A topological service area is defined in relation to a UE's connection point to the network. A topological service area may be defined by a set of Cell IDs, a set of Tracking Area Identities (TAIs), or a PLMN ID. A geographic service area may be an area defined by geographical coordinates, a circle whose center is denoted by geographical coordinates, or an area defined as a polygon whose corners are denoted by geographical coordinates. Geographic service area can be represented in other ways, such as well-known buildings, parks, arenas, civic addresses, zip codes, and so on.

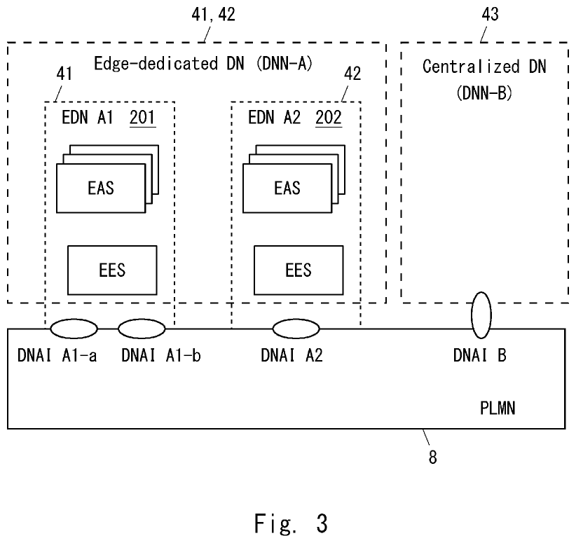

The deployment shown in FIG. 3 uses an edge-dedicated DN to support edge computing services. An edge-dedicated DN is configured with a unique DNN. The edge-dedicated DN identified by DNN-A shown in FIG. 3 corresponds to the DN 41 and DN 42 shown in FIG. 1. In other words, in the example in FIG. 3, the DN 41 and DN 42 are the same DN, distinguished by different DNAIs (e.g., DNAI A1-a, DNAI A1-b, DNAI A2, and DNAI B). One EDN is identified by DNN-A and one or more DNAIs of the edge-dedicated DN. For example, the DN 41 may contain an EDN A1 (201) and may be identified by DNN-A and DNAI A1-a and DNAI A1-b. Meanwhile, the DN 42 may contain an EDN A2 (202) and may be identified by DNN-A and DNAI A2. The centralized DN identified by DNN-B shown in FIG. 3 corresponds to the DN 43 shown in FIG. 1.

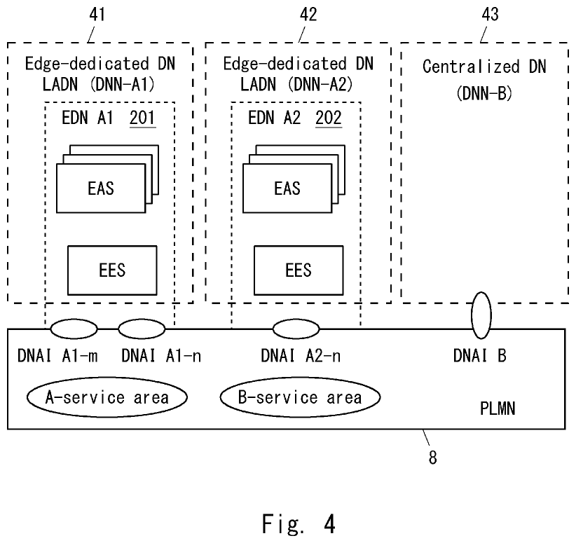

In the example in FIG. 4, EDN A1 (201) and EDN A2 (202) are edge-dedicated data networks deployed as LADNs. As shown in FIG. 4, the DN 41 shown in FIG. 1 may be one LADN identified by DNN-A1, and the DN 42 shown in FIG. 1 may be another LADN identified by DNN-A2. One LADN, the DN 41, may contain an EDN A1 (201) and the other LADN, the DN 42, may contain an EDN A2 (202). The service area of the EDN A1 (201) is the same as the LADN service area of the DN 41. The service area of the EDN A2 (202) is the same as the LADN service area of the DN 42. The service area of the EES within the EDN A1 (201) is the same as or a subset of the EDN service area (i.e., the LADN service area of the DN 41). The service area of an individual EAS within the EDN A1 (201) is identical to or a subset of the service area of the corresponding EES. Similarly, the service area of the EES within the EDN A2 (202) is identical to or a subset of the EDN service area (i.e., the LADN service area of the DN 42). The service area of an individual EAS within the EDN A2 (202) is equal to or a subset of the service area of the corresponding EES.

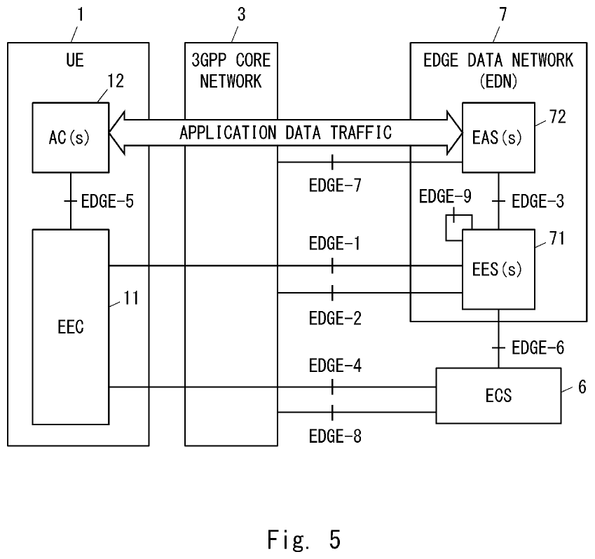

FIG. 5 shows an example of the 3GPP EDGEAPP architecture according to this example embodiment. Each of the elements shown in FIG. 5 is a functional entity, providing functions and interfaces as defined by the 3GPP. Each of the elements (functional entities) shown in FIG. 1 can be implemented, for example, as a network element on dedicated hardware, as a software instance running on dedicated hardware, or as a virtualized function instantiated on an application platform.

In the example in FIG. 5, the UE 1 includes an Edge Enabler Client (EEC) 11 and one or more Application Clients (ACs) 12. In other words, an EEC 11 and one or more ACs 12 are deployed in the UE 1 and run on the UE 1. Although not explicitly shown in FIG. 5, the UE 1 communicates with the 3GPP core network 3 (i.e., 5GC) via the AN 2. In this way, the UE 1 provides the EEC 11 and AC(s) 12 with connectivity to a data network via the AN2 and the core network 3.

The EEC 11 provides supporting functions required by the AC(s) 12. Specifically, the EEC 11 provides provisioning of configuration information to enable the exchange of application data traffic with an Edge Application Server (EAS). In addition, the EEC 11 provides functions for a discovery of one or more EASs available within an EDN 7. The EEC 11 uses EAS endpoint information obtained from the EAS discovery in routing of outgoing application data traffic to an EAS. Further, the EEC 11 provides functions for registration (i.e., registration, update, and de-registration) of an EES 71 and EAS(s) 72.

Each AC 12 is an application running on the UE 1. Each AC 12 connects to one or more EASs to utilize edge computing services and exchanges application data traffic with these EASs.

One EDN 7 includes one or more EESs 71 and one or more EASs 72. As already explained, the EDN 7 may be a LADN. The EESs 71 and EASs 72 may be included in the AF 5 shown in FIG. 1.

Each EES 71 provides supporting functions required by an EAS(s) 72 and the EEC 11. Specifically, each EES 71 provides the EEC 11 with the provisioning of configuration information, thereby enabling the exchange of application data traffic with an EAS(s) 72. Each EES 71 provides functions for registration (i.e., registration, update, and de-registration) of the EEC 11 and EAS(s) 72. Each EES 71 provides functions of application context transfer between EESs. These functions are required for application context relocation (or edge application mobility) for service continuity. The application context is the set of data present in an EAS and related to an AC. Application context relocation involves transferring the application context regarding the user (i.e., AC) from a source EAS (or EDN) to a target EAS (or EDN). Application context relocation is triggered by UE mobility events or non-UE mobility events. UE mobility events include, for example, intra-EDN mobility, inter-EDN mobility, and LADN-related mobility. Non-UE mobility events include, for example, EAS or EDN overload conditions and EAS maintenance (e.g., graceful shutdown of the EAS).

Further, each EES 71 supports the functionality of the Application Programming Interface (API) invoker and the API exposing function. Each EES 71 provides ACR management event notifications functionality to the EAS(s) 72. The ACR management event notifications functionality is the ability to notify EASs of events related to the Application Context Relocation (ACR) of one or more UEs. The types of events (event IDs) include user plane path change detection (i.e., “User plane path change”); user plane path change detection and T-EAS identification (i.e., “ACR monitoring”); user plane path change and T-EAS identification and traffic change appropriate for the T-EAS (i.e., “ACR facilitation”); and whether a UE has moved into or out of a particular location or area (i.e., “Presence-In-Area of Interest (AOI)-Report”). The EAS(s) 72 subscribe in advance to these events provided by the EES 71 in order to receive notifications they seek. The “particular location or area” may be a Tracking Area Identity (TAI) list or Cell IDs, or it may be a TAI list associated with a particular LADN. Each EES 71 may interact with the 3GPP Core Network 3 directly (e.g., via PCF 34) or indirectly (e.g., via NEF 36 or Service Capability Exposure Function (SCEF)) to access services and capabilities of network functions within 3GPP core network 3. Each EES 71 may support external exposure of services and capabilities of 3GPP network functions to the EAS(s) 72. Each EES 71 may support the Application Function influence on traffic routing and may interact with the 5GC 3.

Each EAS 72 is located in the EDN 7 and performs server functions of an application. The server functions of an application may be available only at the edge. In other words, the server functions of an application may be available only as an EAS. However, the server functions of an application may be available both at the edge and in the cloud. In other words, the server functions of an application may be available as an EAS and in addition may be available as an application server in the cloud. The term “cloud” here means a central cloud (e.g., DN 43 in FIGS. 1 to 4) located further away from the UE 1 than the EDN 7(e.g., DN 41 or 42 in FIGS. 1 to 4). Accordingly, an application server in the cloud means a server deployed in a centralized location (e.g., a centralized data center). Each EAS 72 may consume or utilize 3GPP core network capabilities. Each EAS 72 may directly invoke 3GPP Core Network function APIs. Alternatively, each EAS 72 may consume or utilize 3GPP core network capabilities via the EES 71, or via the NEF 36 or SCEF. Each EAS 72 may support Application Function influence on traffic routing and interact with the 5GC 3.

An Edge Configuration Server (ECS) 6 provides supporting functions required by the EEC 11 to connect to the EES(s) 71. Specifically, the ECS 6 provides provisioning of edge configuration information to the EEC 11. The edge configuration information includes information to the EEC 11 for connecting to the EES(s) 71 (e.g., service area information applicable to the LADN) and for establishing a connection to the EES(s) 71 (e.g., Uniform Resource Identifier (URI)). The ECS 6 provides the functionality for registration (i.e., registration, update, and de-registration) of the EES(s) 71. Further, the ECS 6 supports the functionality of the API invoker and the API exposing function. The ECS 6 may interact directly (e.g., via PCF 34) or indirectly (e.g., via NEF 36 or SCEF) with the 3GPP Core Network 3 to access the services and capabilities of the network functions in the 3GPP Core Network 3. The ECS 6 may be located in the MNO domain providing the 3GPP core network 3 or in a third party domain of a service provider (e.g., Edge Computing Service Provider (ECSP)). The ECS 6 may be located in a central cloud (e.g., DN 43 in FIGS. 1 to 4). The ECS 6 may be included in the AF 5 shown in FIG. 1.

The example configuration in FIG. 5 shows only representative elements for illustrative purposes. For example, the ECS 6 may be connected to multiple EDNs.

The operation of the AF 5 according to this example embodiment is described below. The AF 5 sends to the 3GPP core network 3 a first message regarding an event related to a configuration of the UP path for a PDU Session of the UE 1. The event related to the configuration of the UP path for the PDU Session may be, for example, the enforcement of the (re)configuration of the UP path, the enforcement of a change in the configuration of the UP path, or the enforcement of the configuration of a change in the UP path. If the AF 5 receives a second message based on an occurrence of the event from the 3GPP core network 3 before a first predetermined period of time expires after the transmission of the first message, then the AF 5 sends a positive response (AF response) to the second message to the 3GPP core network 3. Otherwise, the AF 5 sends a third message to the 3GPP core network 3 indicating the failure of a process in the AF 5 corresponding to the event. The process in the AF 5 corresponding to the event may be, for example, an Application Context Relocation (ACR) procedure, or it may be a process that corresponds to influences of an AF request. The first predetermined period of time may be determined based on service continuity requirements of an application. The AF Request may be a request to subscribe to a service that provides notifications (e.g., early notifications or late notifications) about the event related to the configuration of the UP path for a PDU Session. The AF response may be a response (positive or negative response) to a notification (e.g., early notification or late notification) about the event for which the service was subscribed to by the AF request.

If the second message based on the occurrence of the event related to the configuration of the UP path for the PDU Session is not received from the 3GPP core network 3 before the expiration of the first predetermined period of time, the AF 5 may determine that the event related to the configuration of the UP path for the PDU Session has failed. The AF 5 may send the third message to the core network 3 based on this determination.

The first message may be a message about Application Function influence on traffic routing of the PDU Session of the UE 1. Thus, the first message regarding the event related to the configuration of the UP path for the PDU Session of the UE 1 may be rephrased as the (first) message regarding Application Function influence on the traffic routing of the PDU Session of the UE 1.

The second message may be a message regarding Application Function influence on the traffic routing of the PDU Session of the UE 1. Alternatively, the second message may be a message regarding runtime coordination between the core network 3 and the AF 5. Thus, the second message may be paraphrased as a (second) message regarding Application Function influence on the traffic routing of the PDU Session of the UE 1, or as a (second) message regarding run-time coordination between the core network 3 and the AF 5. The second message may be related to a change from the original user plane path to a new user plane path for the traffic of the PDU Session. More specifically, the second message may be related to a DNAI change. The second message may be sent directly from the SMF 32 or through the NEF 36 prior to configuring or activating the new user plane path to a new DNAI. The second message may be a notification to begin enforcing the configuration of the user plane path for the PDU session. Alternatively, the second message may be a notification that the configuration of the user plane path for the PDU Session has been enforced (or completed).

The positive response to the second message may cause the SMF 32 in the 3GPP core network 3 to enforce the configuration of the new UP path. Additionally or alternatively, the positive response to the second message may cause the SMF 32 to activate the configuration of the new UP path.

The third message may cause the SMF 32 to continue using the original UP path and cancel the change from the original UP path to the new UP path. The third message may be paraphrased as a negative response to the second message. The third message may be paraphrased as a (third) message causing the 3GPP core network 3 to cancel the event related to the configuration of the UP path for the PDU Session of the UE 1. The third message may be paraphrased as a third message indicating the failure of the event related to the configuration of the UP path for the PDU Session of the UE 1. The third message may be paraphrased as a third message indicating the failure of the process corresponding to the AF influence. The third message may be paraphrased as a third message indicating the failure of the process related to the influence of the AF (request).

In a first implementation, the event related to the configuration of the UP path for the PDU Session is the enforcement of the configuration of the UP path for the PDU Session. In this case, the first message described above is a positive response to an early notification (or first notification). The early notification is sent by the SMF 32 based on the subscription request from the AF 5. More specifically, the SMF 32 sends an early notification to the AF 5 directly or through the NEF 36 before the (new) UP path for the traffic of the PDU Session is configured. For example, an Early notification may be a prior notification of enforcement of the configuration of the UP path for the PDU Session. The subscription request may further include an indication of “AF acknowledgment to be expected”. This indication means that the AF 5 intends to provide a response to the UP path management event notification to the 3GPP core network 3. According to this indication, the SMF 32 may wait for a response from the AF 5 before the SMF 32 configures the new UP path. In this case, the SMF 32 does not configure the new UP path (e.g., the UP path to the new DNAI) until it receives the first message (i.e., the positive AF response to the early notification).

In the first implementation, the second message described above is a late notification. A late notification is sent by the SMF 32 based on a subscription request from the AF 5. More specifically, the SMF 32 sends a late notification to the AF 5 directly or through the NEF 36 after the enforcement (completion) of the configuration of a UP path for the PDU Session and before the activation of this new UP path. For example, the late notification may be sent to inform the AF 5 that the configuration of the UP path for the PDU Session has been enforced. The subscription request contains the indication “AF acknowledgment to be expected”. In accordance with this indication, the SMF 32 waits for a response from the AF 5 before the SMF 32 activates the new UP path. The SMF 32 does not activate the new UP path (e.g., the UP path to the new DNAI) until it receives a positive AF response to the second message (i.e., late notification).

In the first implementation, the positive response to the second message (i.e., late notification) confirms the UP path management event (e.g., DNAI change) indicated in the late notification.

In the first implementation, the third message described above indicates a failure of the process corresponding to the influence of the AF request, specifically a failure of the process in the AF 5 (e.g., the ACR procedure) corresponding to an event related to the configuration of the UP path for the PDU Session. The third message rejects the UP path management event (e.g., DNAI change) indicated in the late notification. The third message may be a negative response to the second message (i.e., late notification). If the SMF 32 receives the third message, the SMF 32 continues to use the original UP path (e.g., the UP path to the original DNAI) and cancels the relocation or addition of the associated PSA.

Alternatively, in a second implementation, the event related to the configuration of the UP path for the PDU Session is the enforcement of the configuration of the UP path for the PDU Session. Alternatively, the event related to the configuration of the UP path for the PDU Session may be the satisfaction of a condition for UP path management event notification. In this case, the first message described above is an AF request regarding AF influence on traffic routing. The AF 5 sends an AF request to the PCF 34 directly or through the NEF 36. The AF request can influence the routing decision by the SMF 32 for the traffic in the PDU Session of UE 1. The AF request can cause the SMF 32 to enforce the configuration of the UP path for the PDU Session of the UE 1. Specifically, based on the AF request, the PCF 34 generates a PCC rule containing control information on AF influence on traffic routing (i.e., AF influenced Traffic Steering Enforcement Control information), and supplies it (via UDR) to the SMF 32. In addition, the AF request contains a subscription request for an early notification of a UP path management event (e.g., DNAI change). The subscription request contains the indication “AF acknowledgment to be expected”. The AF request may further contain a request for subscription to a late notification.

In the second implementation, the second message described above is an early notification. More specifically, the SMF 32 sends an early notification to the AF 5 directly or through the NEF 36 prior to the enforcement of the configuration of the UP path for the PDU

Session. For example, the early notification may be a prior notification of the enforcement of the configuration of the UP path for the PDU Session. The early notification is sent by the SMF 32 based on a subscription request from the AF 5. In accordance with the indication “AF acknowledgment to be expected”, the SMF 32 does not set up a new UP path (e.g., the UP path to the new DNAI) until it receives a positive response to the second message (i.e., early notification).

In the second implementation, the positive response to the second message (i.e., early notification) confirms the UP path management event (e.g., DNAI change) indicated in the early notification.

In the second implementation, the third message described above indicates a failure of the process corresponding to the influence of the AF request, specifically a failure of the process in the AF 5 (e.g., the ACR procedure) corresponding to an event related to the configuration of the UP path for the PDU Session. The third message rejects the UP path management event (e.g., DNAI change) indicated in the early notification. The third message may be a negative response to the second message (i.e., early notification). If the SMF 32 receives the third message, the SMF 32 continues to use the original UP path (e.g., UP path to the original DNAI) and cancels the relocation or addition of the associated PSA.

In a third implementation, the event related to the configuration of the UP path for the PDU Session is the enforcement of the configuration of the UP path for the PDU Session. Alternatively, the event related to the configuration of the UP path for the PDU Session may be the satisfaction of a condition for UP path management event notification. In this case, similar to the second implementation, the first message described above is an AF request regarding AF influence on traffic routing. The AF 5 sends an AF request to the PCF 34 directly or through the NEF 36. The AF request can influence the routing decision by the SMF 32 for the traffic in the PDU Session of UE 1. The AF request can cause the SMF 32 to enforce the configuration of the UP path for the PDU Session of the UE 1. In addition, the AF request contains a subscription request for a late notification of a UP path management event (e.g., DNAI change). The subscription request contains the indication “AF acknowledgment to be expected”. The AF request may further contain a request for subscription to an early notification.

In the third implementation, the second message described above is a late notification, as in the first implementation. A late notification is sent by the SMF 32 based on a subscription request from the AF 5. More specifically, the SMF 32 sends a late notification to the AF 5 directly or through the NEF 36 after the enforcement (completion) of the configuration of a UP path for the PDU Session and before the activation of this new UP path. For example, the late notification may be sent to inform the AF 5 that the configuration of the UP path for the PDU Session has been enforced. In accordance with the indication “AF acknowledgment to be expected”, the SMF32 does not activate the new UP path (e.g., the UP path to the new DNAI) until it receives a positive AF response to the second message (i.e., late notification).

In the third implementation, the positive response to the second message (i.e., late notification) confirms the UP path management event (e.g., DNAI change) indicated in the late notification.

In the third implementation, the third message described above indicates a failure of the process corresponding to the influence of the AF request, specifically a failure of the process in the AF 5 (e.g., the ACR procedure) corresponding to an event related to the configuration of the UP path for the PDU Session. The third message rejects the UP path management event (e.g., DNAI change) indicated in the late notification. The third message may be a negative response to the second message (i.e., late notification). If the third message is received by the SMF 32, the SMF 32 continues to use the original UP path (e.g., the UP path to the original DNAI) and cancels the relocation or addition of the associated PSA.

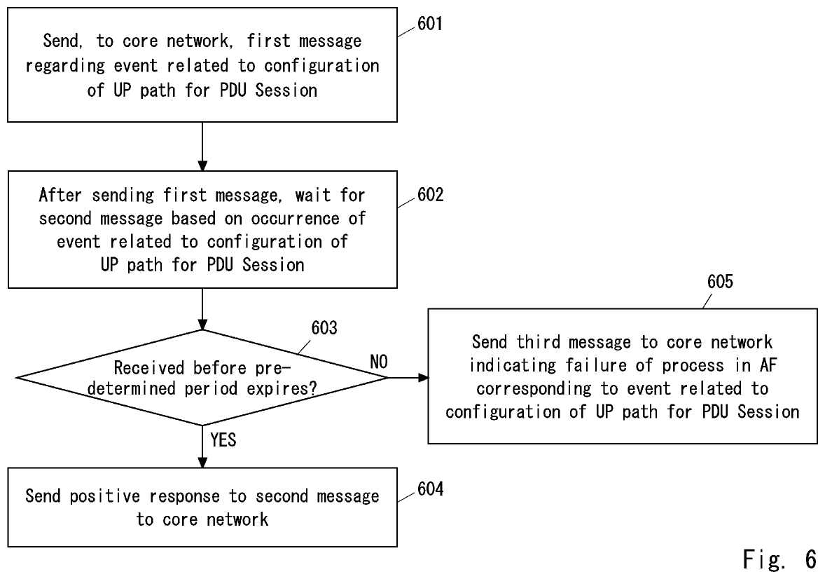

FIG. 6 is a flowchart showing an example of the operation of the AF 5 according to this example embodiment. In step 601, the AF 5 sends to the 3GPP core network 3 a first message regarding an event related to the configuration of a UP path for a PDU Session. In step 602, after sending the first message, the AF 5 waits for a second message based on the occurrence of the event related to the configuration of the UP path for the PDU Session. The AF 5 may start a timer to count the first predetermined period of time after, upon, or in response to the transmission of the first message. The event related to the configuration of the UP path for the PDU Session may be, for example, the enforcement of the (re)configuration of the UP path for the PDU Session, the enforcement of a change in the configuration of the UP path, or the enforcement of the configuration of a change in the UP path for the PDU Session.

As already described, the AF 5 may include the EES 71 or the EAS 72. For example, the AF 5 may include a Source EES (S-EES) or Source EAS (S-EAS). The AF 5 may, in parallel with one or both of steps 601 and 602, perform signaling with other network functions (e.g., EEC, T-EES, T-EAS) related to the Application Context Relocation (ACR) procedure. The ACR procedure involves transferring the application context about the user (i.e., AC 12) from the S-EES to the Target EAS (T-EAS).

If the AF 5 receives the second message from the 3GPP core network 3 before the first predetermined period of time expires after the transmission of the first message (YES in step 603), the AF 5 sends a positive response to the second message to the 3GPP core network 3 (step 604). The AF 5 stops the timer. In contrast, if the AF 5 does not receive the second message from the 3GPP core network 3 before the first predetermined period of time expires (NO in step 603), the AF 5 determines that the procedure in the 3GPP core network 3 regarding the AF influence on traffic routing (e.g., the UPF reallocation or addition) is delayed. The AF 5 then sends a third message to the 3GPP core network 3 indicating the failure of the process in the AF 5 corresponding to the event regarding the configuration of the UP path for the PDU Session (step 605). The third message may be a negative response to the second message. The third message may be a message indicating a failure in the processing for the influence of the AF request.

According to the operation of the AF 5 in this example embodiment, if the AF 5 has not received the second message from the 3GPP core network 3 by the expiration of the first predetermined period of time, the AF 5 can determine that the procedure (e.g., the UPF reallocation or addition procedure) within the 3GPP core network 3 regarding the AF influence on traffic routing is delayed and can cancel this procedure. This allows the AF 5 to deal with the delay of the procedure in the 3GPP core network 3 regarding the AF influence on traffic routing.

For example, if the AF 5 did not receive the second message from the 3GPP core network 3 before the expiration of the first predetermined period of time, the AF 5 may cancel the ACR procedure. The cancellation of the ACR procedure involves the AC 12 of the UE 1 continuing to use the S-EAS. To enable this, if the AF 5 includes the S-EES, the AF 5 may send an indication of the failure of the ACR procedure to the EEC 11 of the UE 1 if the AF 5 did not receive the second message from the 3GPP core network 3 before the expiration of the first predetermined period of time. The failure of the ACR procedure is due to a delay in the procedure (e.g., UPF relocation or addition) within the 3GPP core network 3 regarding AF influence on traffic routing. The indication of the failure of the ACR procedure may explicitly indicate that the failure is due to a delay in the procedure (e.g., UPF reallocation or addition) within the 3GPP core network 3. If the AF 5 contains the S-EAS, the AF 5 may request the S-EES to send the indication of the failure of the ACR procedure to the EEC 11 of the UE 1 if the AF 5 has not received the second message from the 3GPP core network 3 before the expiration of the first predetermined period of time. Upon receipt of such indication, the EEC 11 of the UE 1 may restore (or activate) the profile of the S-EAS, if this profile has been invalidated.

### Second Example Embodiment

This example embodiment provides a detailed example of the operation of the AF 5 described in the first example embodiment, as well as detailed examples of the operation of other network functions that may be useful for this purpose. The example network architecture according to this example embodiment is similar to the examples described with reference to FIGS. 1 to 5.

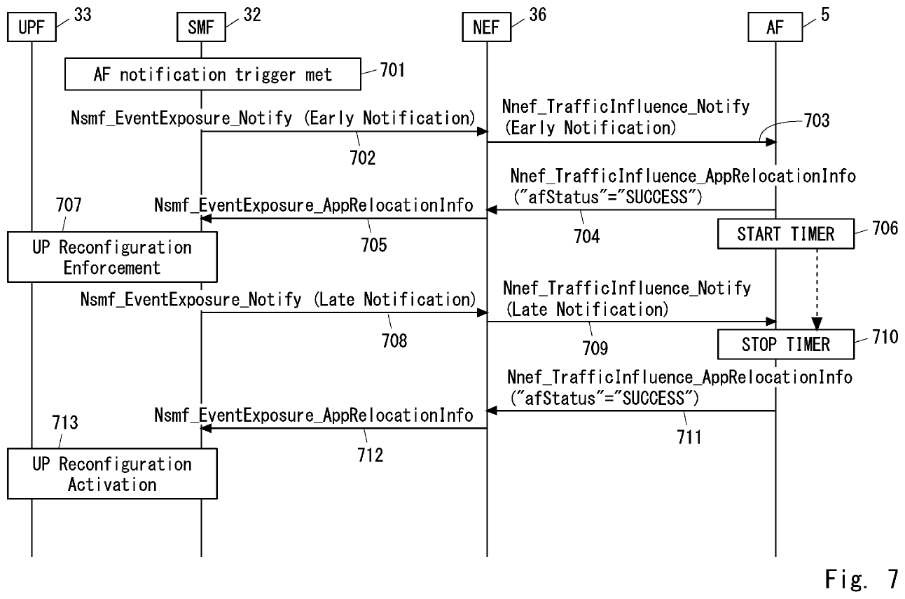

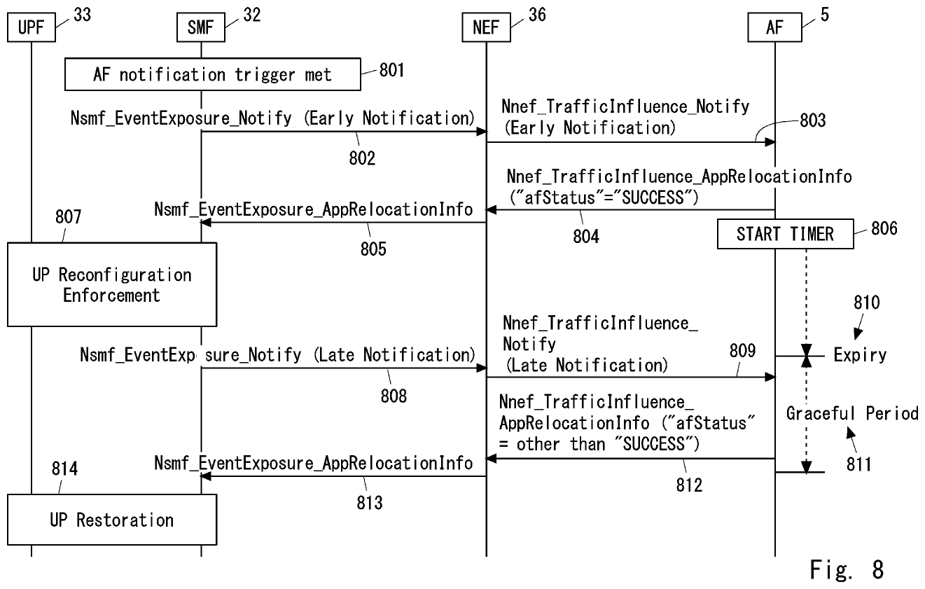

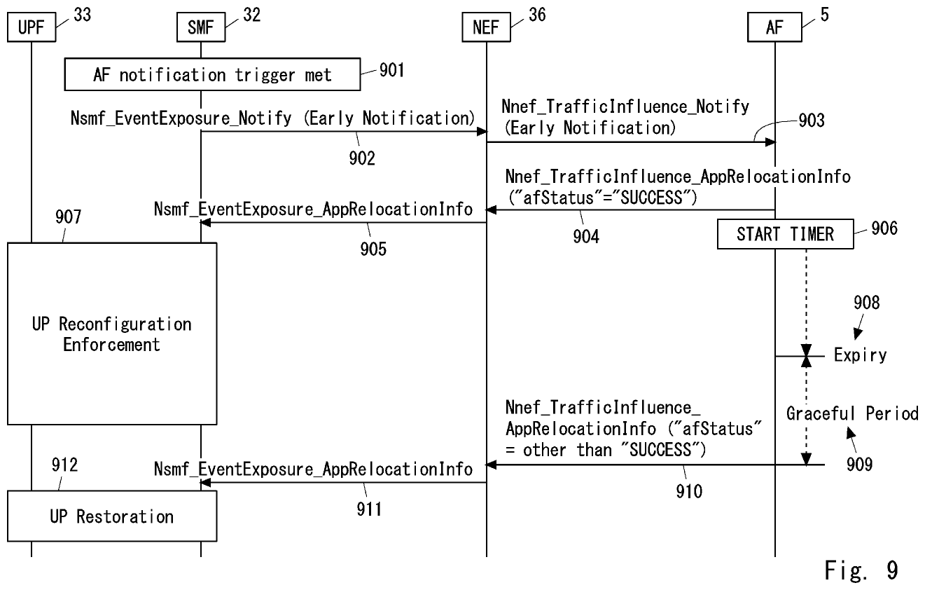

FIGS. 7 to 9 are sequence diagrams showing examples of the operation of the AF 5, SMF 32, UPF 33, and NEF 36. The AF 5 may include an S-EES or S-EAS. The examples shown in FIGS. 7 to 9 correspond to the first implementation described in the first example embodiment. That is, the AF 5 sends a first message (i.e., a positive response to an early notification from the SMF 32) directly to the SMF 32 or through the NEF 36. Then, if the AF 5 receives a second message (i.e., late notification) before the expiration of the first predetermined period of time after the transmission of the positive response to the early notification, the AF 5 sends a positive response to the late notification either directly to the SMF 32 or via NEF 36 (FIG. 7). The occurrence of an event related to the configuration of the UP path for a PDU session may be, for example, the enforcement of the configuration of the UP path for the PDU session. If the AF 5 does not receive the second message (i.e., late notification) before the expiration of the first predetermined period of time after the transmission of the positive response to the early notification, the AF 5 sends a third message (indicating a failure of the AF 5 processing corresponding to the event) directly to the SMF 32 or through the NEF 36 (FIGS. 8 and 9). The third message may be a negative response to the late notification. The third message may be a message indicating a failure in the processing for the influence of the AF request.

FIG. 7 is described first. FIG. 7 shows the case where the AF 5 receives a late notification based on the occurrence of an event related to the enforcement of the configuration of the UP path for the PDU Session before the expiration of the first predetermined period of time, and the AF 5 sends a positive response to the late notification. In step 701, the SMF 32 determines (or detects) that a condition for an early notification of a UP path management event notification, to which the AF 5 has subscribed, has been met. The UP path management event may be that a PSA has been established or released, or that the DNAI has changed. The UP path management event may be that the SMF 32 has received an AF request and that the ongoing PDU Session meets a condition for notification to the AF 5. The SMF 32 may use the notification reporting information received from the PCF 34 to issue the notification to the AF 5 directly or through the NEF 36. The notification reporting information may be included in PCC rules.

In step 702, if early notification via NEF has been requested by the AF 5, the SMF 32 informs the NEF 36 of the Target DNAI by invoking the Nsmf_EventExposure_Notify service operation. In step 703, the NEF 36 performs information mapping and triggers an appropriate Nnef_TrafficInfluence_Notify message. The information mapping includes, for example, replacing the AF Transaction Internal ID with the AF Transaction ID and replacing the Subscription Permanent Identifier (SUPI) of the UE 1 with the Generic Public Subscription Identifier (GPSI) in the UE 1. If early direct notification has been requested by the AF 5, instead of steps 702 and 703, the SMF 32 notifies the AF 5 of the Target DNAI by invoking the Nsmf_EventExposure_Notify service operation.

In step 704, the AF 5 sends to the NEF 36 a positive response to the early notification about the event regarding the configuration of the UP path for the PDU Session. Specifically, the AF 5 replies to the Nnef_TrafficInfluence_Notify by invoking the Nnef_TrafficInfluence_AppRelocationInfo service operation service operation. The AF 5 may immediately invoke the Nnef_TrafficInfluence_AppRelocationInfo service operation. Alternatively, the AF 5 may call the Nnef_TrafficInfluence_AppRelocationInfo service operation after the application layer is ready or after any required application relocation to the Target DNAI is completed. The AF 5 includes in the payload of the HTTP POST message an AfAckInfo data type that contains an “afStatus” attribute set to “SUCCESS”. This indicates a positive response to the early notification.

In step 705, the NEF 36 triggers an appropriate Nsmf_EventExposure_AppRelocationInfo in response to the receipt of the Nnef_TrafficInfluence_AppRelocationInfo. If the AF 5 receives an early direct notification, instead of steps 704 and 705, the AF 5 may invoke the Nsmf_EventExposure_AppRelocationInfo service operation to respond to the Nsmf_EventExposure_Notify.

In step 706, the AF 5 starts a timer to count the first predetermined period of time. For example, but not limited to, the AF 5 may start the timer after, upon, or in response to transmitting the positive response to the early notification.

In step 707, the SMF 32 enforces the configuration of the UP path for the PDU Session (UP reconfiguration Enforcement). Specifically, the SMF 32 exchanges control messages with the UPF 33 to enforce the user plane (UP) reconfiguration. The SMF 32 relocates or adds a PSA to configure a new UP path to the Target DNAI. Relocating or adding a PSA involves one or any combination of the addition, modification, and removal of one or more UPFs. If the subscription request for early notification contains the indication “AF acknowledgment to be expected”, then based on this indication, the SMF5 does not configure the UP path to the new DNAI until it receives the positive response in step 706. If the subscription request to early notification did not contain the indication “AF acknowledgment to be expected”, then the SMF5 may enforce the configuration of the UP path to the new DNAI without waiting for a positive response to the early notification. However, before the UP path to the new DNAI is activated, the application traffic data continues to be routed to the old DNAI.

In step 708, if late notification via the NEF has been requested by the AF 5, the SMF 32 notifies the NEF 36 of the Target DNAI by calling the Nsmf_EventExposure_Notify service operation. In step 709, the NEF 36 performs information mapping and triggers the appropriate Nnef_TrafficInfluence_Notify message. If late direct notification has been requested by the AF 5, then instead of steps 708 and 709, the SMF 32 notifies the AF 5 of the Target DNAI by invoking the Nsmf_EventExposure_Notify service operation. The subscription request to the late (direct) notification contains the indication “AF acknowledgment to be expected”. According to this indication, the SMF 32 waits for a response from the AF 5 before the SMF 32 activates the new UP path. The SMF 32 does not activate the new UP path (e.g., the UP path to the new DNAI) until it receives a positive AF response to the late (direct) notification.

In step 710, the AF 5 stops the timer in response to receiving a late notification before the timer expires. The late notification is based on the occurrence of an event related to the configuration of the UP path for the PDU Session. In step 711, the AF 5 sends a positive response to the late notification to the NEF 36. Specifically, the AF 5 responds to the Nnef_TrafficInfluence_Notify by invoking the Nnef_TrafficInfluence_AppRelocationInfo service operation. The AF 5 may immediately invoke the Nnef_TrafficInfluence_AppRelocationInfo service operation. Alternatively, the AF 5 may call the Nnef_TrafficInfluence_AppRelocationInfo service operation after the application layer is ready or after any required application relocation to the Target DNAI is completed. The AF 5 includes in the payload of the HTTP POST message an AfAckInfo data type that contains an “afStatus” attribute set to “SUCCESS”. This indicates a positive response to the late notification.

In step 712, the NEF 36 triggers an appropriate Nsmf_EventExposure_AppRelocationInfo in response to the receipt of the Nnef_TrafficInfluence_AppRelocationInfo. If the AF 5 receives a late direct notification, instead of steps 711 and 712, the AF 5 may respond to the Nsmf_EventExposure_Notify by invoking the Nsmf_EventExposure_AppRelocationInfo service operation.

In step 713, the SMF 32 exchanges control messages with the UPF 33 to activate the UP reconfiguration (UP Reconfiguration Activation). In other words, the SMF 32 activates the UP path to the new DNAI. The relevant application traffic data is then routed to the new DNAI.

FIG. 8 shows the case where the first predetermined period of time expires before the AF 5 receives the late notification, and the AF 5 receives the late notification during the second predetermined period of time after the first predetermined period of time expires. The second predetermined period may be referred to as the graceful period. Steps 801-809 in FIG. 8 are similar to steps 701-709 in FIG. 7. However, in the case of FIG. 8, the AF 5 receives a late notification (809) during the graceful period (811) after the timer expires (810). Upon the expiration (810) of the timer, the AF 5 may determine that the process being performed in the AF 5 has failed due to delays in the 3GPP core network 3.

In step 812, in response to receiving the late notification after the timer expires, the AF 5 sends a negative response to the late notification to the NEF 36. Specifically, the AF 5 replies to the Nnef_TrafficInfluence_Notify by calling the Nnef_TrafficInfluence_AppRelocationInfo service operation. The AF 5 may immediately invoke the Nnef_TrafficInfluence_AppRelocationInfo service operation. Alternatively, the AF 5 may invoke the Nnef TrafficInfluence_AppRelocationInfo service operation after the cancellation of the application relocation has been completed.

The AF 5 includes in the payload of the HTTP POST message (step 812) an AfAckInfo data type that contains an “afStatus” attribute set to a value other than “SUCCESS”. This indicates a negative response to the late notification. The “afStatus” attribute set to a value other than “SUCCESS” indicates a failure cause. The value other than “SUCCESS” may be “TEMP_CONGESTION”, “RELOC_NO_ALLOWED”, or “OTHER”. The value “TEMP_CONGESTION” indicates that the application relocation fails due to temporary congestion. The value “RELOC_NO_ALLOWED” indicates that the application relocation fails because the application relocation is not allowed. The value “OTHER” indicates that the application relocation fails due to other reasons. Alternatively, the “afStatus” attribute may explicitly indicate that the processing corresponding to the influence of the AF request has failed due to processing delays in the 3GPP core network. Additionally or alternatively, the “afStatus” attribute may explicitly indicate that the application relocation process has failed based on the expiration of the timer for managing the process in the 3GPP core network. For example, the AF 5 may include in the payload of the HTTP POST message (step 812) an AfAckInfo data type containing an “afStatus” attribute set to a value of “Failure_because_5GC_delay” or “RELOC_TIMER_EXPIRED”.

In step 813, the NEF 36 triggers the appropriate Nsmf_EventExposure_AppRelocationInfo in response to receiving the Nnef_TrafficInfluence_AppRelocationInfo. If the AF 5 has received a late direct notification, then instead of steps 812 and 813, the AF 5 may invoke the Nsmf_EventExposure_AppRelocationInfo service operation to respond to the Nsmf_EventExposure_Notify.

In step 814, the SMF 32 exchanges control messages with the UPF 33 to restore the UP path to the original DNAI. Alternatively, the SMF 32 disables the configuration of the UP path to the new DNAI. The SMF 32 continues using the UP path to the original DNAI and cancels the change to the UP path to the new DNAI.

FIG. 9 illustrates the case where the AF 5 has not received a late notification even during the second predetermined period of time (i.e., the graceful period) after the first predetermined period of time has elapsed. Steps 901-907 in FIG. 9 are similar to steps 701-707 in FIG. 7.

When the timer expires (908), the AF 5 may determine that the process being performed in the AF 5 has failed due to delays in the 3GPP core network 3. If the graceful period (909) elapses after the timer expires (908), then in step 910, the AF 5 sends a message indicating the failure of the processing corresponding to the influence of the AF request. In implementation, this negative response can be implemented as a negative response to a late notification or as a negative response to an early notification. Specifically, the AF 5 replies to the Nnef_TrafficInfluence_Notify by calling the Nnef_TrafficInfluence_AppRelocationInfo service operation. The AF 5 may immediately invoke the Nnef_TrafficInfluence_AppRelocationInfo service operation. Alternatively, the AF 5 may invoke the Nnef_TrafficInfluence_AppRelocationInfo service operation after the cancellation of the application relocation has been completed.

The AF 5 includes in the payload of the HTTP POST message (step 910) an AfAckInfo data type that contains an “afStatus” attribute set to a value other than “SUCCESS”. This indicates a negative response to a late notification. The AF 5 may include an AfAckInfo data type containing an “afStatus” attribute set to a value of “Failure_because_5GC_delay” or “RELOC_TIMER_EXPIRED” in the payload of the HTTP POST message (step 910). This indicates that the processing corresponding to the influence of the AF request has failed due to processing delays in the 3GPP core network 3. Additionally or alternatively, this indicates that the application context relocation procedure failed based on the expiration of the timer for managing the process in the 3GPP core network 3.

In step 911, the NEF 36 triggers the appropriate Nsmf_EventExposure_AppRelocationInfo in response to receiving the Nnef_TrafficInfluence_AppRelocationInfo. Instead of steps 910 and 912, the AF 5 may send a negative response directly to the SMF 32 by invoking the Nsmf_EventExposure_AppRelocationInfo service operation.

In step 912, the SMF 32 exchanges control messages with the UPF 33 to restore the UP path to the original DNAI. Alternatively, the SMF 32 disables the configuration of the UP path to the new DNAI. The SMF 32 continues to use the UP path to the original DNAI and cancels the change to the UP path to the new DNAI.

The procedures shown in FIG. 8 and FIG. 9 may not have the graceful period (811, 909). In this case, if the timer expires (or the first predetermined period of time elapses) before the AF 5 receives the late notification, the AF 5 may send a message (e.g., a negative response to the late notification) indicating a failure in the processing corresponding to the influence of the AF request.

According to the procedure described in this example embodiment, if the AF 5 has not received a late notification from the 3GPP core network 3 by the expiration of the first predetermined period of time after sending a positive response to an early notification, then the AF 5 can determine that the procedure (e.g., UPF relocation or addition) within the 3GPP core network 3 regarding the AF influence on traffic routing is delayed and can cancel this procedure. This allows the AF 5 to deal with the delay of the procedure in the 3GPP core network 3 regarding the AF influence on traffic routing.

### Third Example Embodiment

This example embodiment provides a detailed example of the operation of the AF 5 described in the first example embodiment, as well as detailed examples of the operation of other network functions that may be useful for this purpose. The example network architecture according to this example embodiment is similar to the examples described with reference to FIGS. 1 to 5.

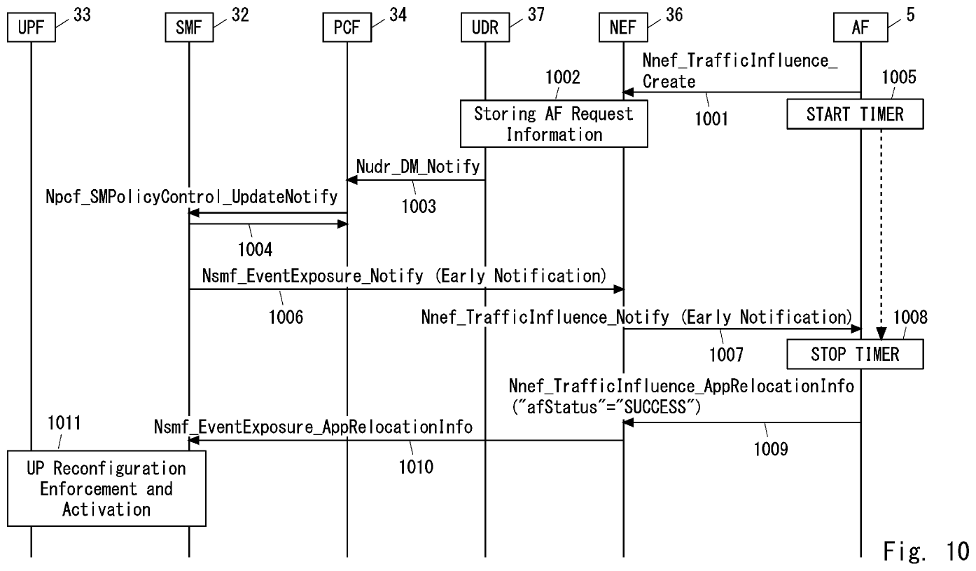

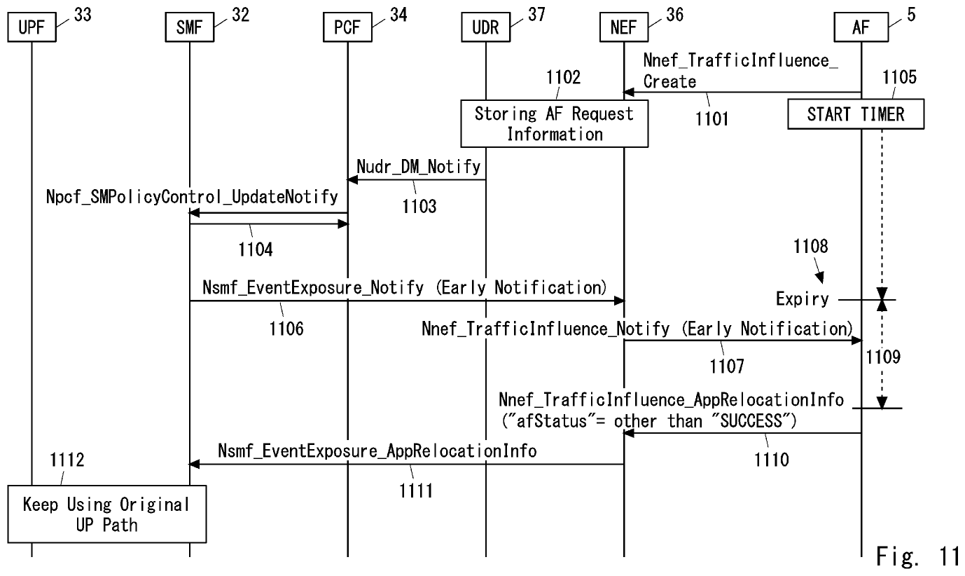

FIGS. 10 and 11 are sequence diagrams showing examples of the operation of the AF 5, SMF 32, UPF 33, PCF 34, NEF 36, and UDR 37. The AF 5 may include an S-EES or S-EAS. The examples shown in FIGS. 10 and 11 correspond to the second implementation described in the first example embodiment. That is, the AF 5 sends a first message (i.e., an AF request regarding AF influence on traffic routing) directly to the PCF 34 or through the NEF 36. The AF request relates to an event associated with the enforcement of the configuration of the UP path for a PDU Session. In addition, the AF request relates to a subscription to a UP path management event notification. The event related to the configuration of the UP path for the PDU Session is the enforcement of the configuration of the UP path for the PDU Session. Alternatively, the event related to the configuration of the UP path for the PDU Session may be the satisfaction of a condition for UP path management event notification.

The AF request requests the 3GPP core network 3 to reconfigure the UP path (e.g., change to the Target DNAI) for the traffic in an ongoing PDU Session of the UE 1. The AF request further includes at least a subscription request to early notification. Then, if the AF 5 receives a second message (i.e., early notification) after sending the AF request but before the expiration of the first predetermined period of time, the AF 5 sends a positive response to the early notification to the SMF 32 directly or through the NEF 36 (FIG. 10). The early notification is sent based on the occurrence of an event related to the configuration of the UP path for the PDU Session. Otherwise, the AF 5 sends a third message (indicating the failure of the processing of the AF 5 corresponding to the event) to the SMF 32, either directly or via the NEF 36 (FIG. 11). This third message may be a negative response to the early notification. The third message may be a message indicating a failure of the processing for the influence of the AF request.

FIG. 10 shows the case where the AF 5 receives an early notification based on the occurrence of an event related to the configuration of the UP path for the PDU Session before the first predetermined period of time expires, and the AF 5 sends a positive response to the early notification. In step 1001, the AF 5 sends an AF request to the NEF 36 by invoking the Nnef_TrafficInfluence_Create service operation. The AF request requests the 3GPP core network 3 to reconfigure the UP path (e.g., change to Target DNAI) for the traffic in the ongoing PDU Session of the UE 1. The Nnef_TrafficInfluence_Create may contain a notification reporting request for UP path change. In step 1002, the NEF 36 stores the information about the AF request in the UDR 37. In step 1003, the PCF 34 receives a Nudr_DM_Notify notification from the UDR 37 about the data change. Instead of steps 1001-1003, the AF 5 may send the AF request directly to the PCF 34 via a direct interface with the PCF 34 (i.e., the N5 interface).

In step 1004, the PCF 34 determines whether an existing PDU Session may be affected by the AF request. Then, for that PDU Session, the PDF 34 updates the SMF 32 with the corresponding new PCC rules by invoking the Npcf_SMPolicyControl_UpdateNotify service operation. If the AF request contains a request for one or both of early notification and late notification for a UP path management event (e.g., DNAI change), the PCF 34 includes in the PCC rule the information required for the reporting of that event. Here, the PCC rule includes the information required for early notification of the event. The PCC rule may also contain the information required for late notification of the event.

In step 1005, the AF 5 starts a timer to count the first predetermined period of time. For example, but not limited to, the AF 5 may start the timer after, upon, or in response to the transmission of the AF request.

In step 1006, the SMF 32 performs an event related to the configuration of the UP path for the PDU Session. Specifically, the SMF 32 determines (or detects) that the condition of the early notification regarding the UP path management event notification subscribed to by the AF 5 has been met. The UP path management event may be that the SMF 32 has received an AF request and that the ongoing PDU Session has met the condition for notification to the AF 5. If early notification via NEF has been requested by the AF 5, the SMF 32 informs the NEF 36 of the Target DNAI by invoking the Nsmf_EventExposure_Notify service operation. In step 1007, the NEF 36 performs information mapping and triggers an appropriate Nnef_TrafficInfluence_Notify message. If early direct notification has been requested by the AF 5, instead of steps 1006 and 1007, the SMF 32 notifies the AF 5 of the Target DNAI by invoking the Nsmf_EventExposure_Notify service operation.

In step 1008, the AF 5 stops the timer in response to receiving an early notification before the timer expires. The early notification is based on the occurrence of an event related to the configuration of the UP path for the PDU Session (i.e., the satisfaction of the condition of the early notification regarding the UP path management event notification). In step 1009, the AF 5 sends a positive response to the early notification to the NEF 36. Specifically, the AF 5 responds to the Nnef_TrafficInfluence_Notify by invoking the Nnef_TrafficInfluence_AppRelocationInfo service operation. The AF 5 may immediately invoke the Nnef_TrafficInfluence_AppRelocationInfo service operation. Alternatively, the AF 5 may call the Nnef_TrafficInfluence_AppRelocationInfo service operation after the application layer is ready or after any required application relocation to the Target DNAI is completed. The AF 5 includes in the payload of the HTTP POST message an AfAckInfo data type that contains an “afStatus” attribute set to “SUCCESS”. This indicates a positive response to the early notification.

In step 1010, the NEF 36 triggers an appropriate Nsmf_EventExposure_AppRelocationInfo in response to the receipt of the Nnef_TrafficInfluence_AppRelocationInfo. If the AF 5 receives an early direct notification, instead of steps 1009 and 1010, the AF 5 may respond to the Nsmf_EventExposure_Notify by invoking the Nsmf_EventExposure_AppRelocationInfo service operation.

In step 1011, the SMF 32 exchanges control messages with the UPF 33 to enforce and activate the UP reconfiguration (UP Reconfiguration Enforcement and Activation). In other words, the SMF 32 configures and activates the UP path to the new DNAI. The relevant application traffic data is then routed to the new DNAI. If a late notification has been requested, then SMF 5 may send a late notification to the AF 5 directly or via the NEF 36 after enforcing the UP reconfiguration. In addition, if the subscription request to the late notification contains the indication “AF acknowledgment to be expected”, according to this indication, the SMF 32 may wait for a response from the AF 5 before activating the new UP path.

FIG. 11 shows the case where the first predetermined period of time expires before the AF 5 receives an early notification based on the occurrence of an event related to the configuration of the UP path for the PDU Session. Steps 1101-1107 in FIG. 11 are similar to steps 1001-1007 in FIG. 10. However, in the case of FIG. 11, the AF 5 receives an early notification (1107) during the graceful period (1109) after the timer expires (1108). The AF 5 may determine that the process being performed in the AF 5 has failed based on delays in the 3GPP core network.

In step 1110, in response to receiving the early notification after the expiration of the timer, the AF 5 sends a message to the NEF 36 indicating a failure of the processing corresponding to the influence of the AF request, specifically a failure of the process in the AF 5 corresponding to an event related to the configuration of the UP path for the PDU Session. The message may be a negative response by the AF 5 to the early notification. Specifically, the AF 5 replies to the Nnef_TrafficInfluence_Notify by calling the Nnef_TrafficInfluence_AppRelocationInfo service operation. The AF 5 may immediately invoke the Nnef_TrafficInfluence_AppRelocationInfo service operation. Alternatively, the AF 5 may invoke the Nnef_TrafficInfluence_AppRelocationInfo service operation after the cancellation of the application relocation has been completed.

The AF 5 includes in the payload of the HTTP POST message (step 1110) an AfAckInfo data type that contains an “afStatus” attribute set to a value other than “SUCCESS”. This indicates a negative response to the early notification. The “afStatus” attribute set to a value other than “SUCCESS” indicates a failure cause. The value other than “SUCCESS” may be “TEMP_CONGESTION”, “RELOC_NO_ALLOWED”, or “OTHER”. The value “TEMP_CONGESTION” indicates that the application relocation fails due to temporary congestion. The value “RELOC_NO_ALLOWED” indicates that the application relocation fails because the application relocation is not allowed. The value “OTHER” indicates that the application relocation fails due to other reasons. Alternatively, the “afStatus” attribute may explicitly indicate that the processing corresponding to the influence of the AF request has failed due to processing delays in the 3GPP core network. Additionally or alternatively, the “afStatus” attribute may explicitly indicate that the application relocation process has failed based on the expiration of the timer for managing the process in the 3GPP core network. For example, the AF 5 may include in the payload of the HTTP POST message (step 1110) an AfAckInfo data type containing an “afStatus” attribute set to a value of “Failure_because_5GC_delay” or “RELOC_TIMER_EXPIRED”.

In step 1111, the NEF 36 triggers the appropriate Nsmf_EventExposure_AppRelocationInfo in response to receiving the Nnef_TrafficInfluence_AppRelocationInfo. If the AF 5 has received an early direct notification, then instead of steps 1110 and 1111, the AF 5 may invoke the Nsmf_EventExposure_AppRelocationInfo service operation to respond to the Nsmf_EventExposure_Notify.

In step 1112, the SMF 32 keeps using the UP path to the original DNAI and cancels the change to the UP path to the new DNAI. Here, “canceling the change to the UP path to the new DNAI” may mean disabling the configuration of the UP path to the new DNAI.

In the procedure shown in FIG. 11, if the graceful period (1109) has elapsed before the AF 5 receives the early notification, the AF 5 may, after, or depending on, or in response to, the elapse of the graceful period, send a message (e.g., a negative response to the early notification) indicating a failure in the processing corresponding to the influence of the AF request. The procedure shown in FIG. 11 may not have the graceful period (1109). In this case, if the timer expires (or the first predetermined period of time elapses) before the AF 5 receives the early notification, the AF 5 may send a message (e.g., a negative response to the early notification) indicating a failure in the processing corresponding to the influence of the AF request.

According to the procedure described in this example embodiment, if the AF 5 has not received an early notification from the 3GPP core network 3 by the expiration of the first predetermined period of time after sending an AF request, the AF 5 can determine that the procedure (e.g., UPF relocation or addition) in the 3GPP core network 3 regarding the AF influence on traffic routing is delayed, and can cancel this procedure. This allows the AF 5 to deal with the delay of the procedure in the 3GPP core network 3 regarding the AF influence on traffic routing.

### Fourth Example Embodiment

This example embodiment provides a detailed example of the operation of the AF 5 described in the first example embodiment, as well as detailed examples of the operation of other network functions that may be useful for this purpose. The example network architecture according to this example embodiment is similar to the examples described with reference to FIGS. 1 to 5.

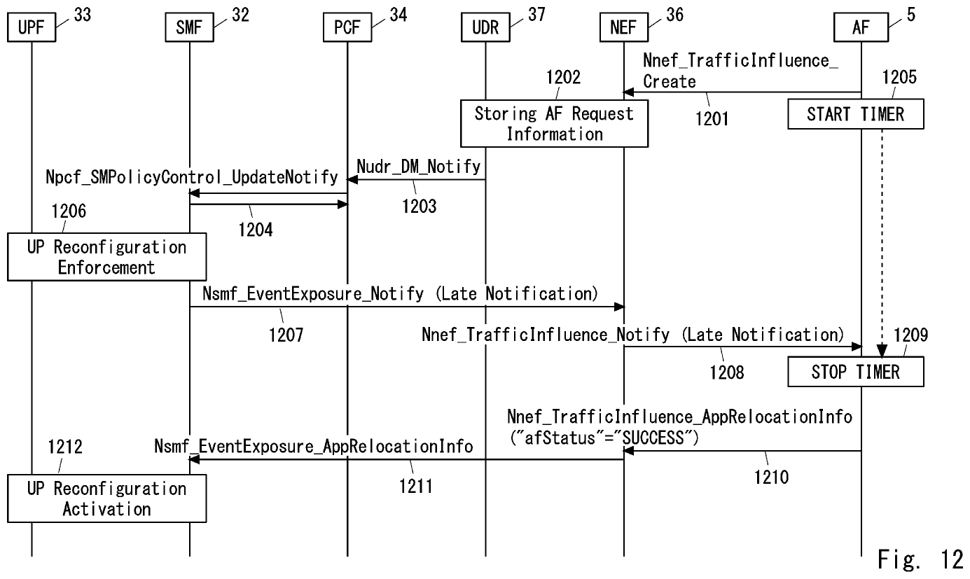

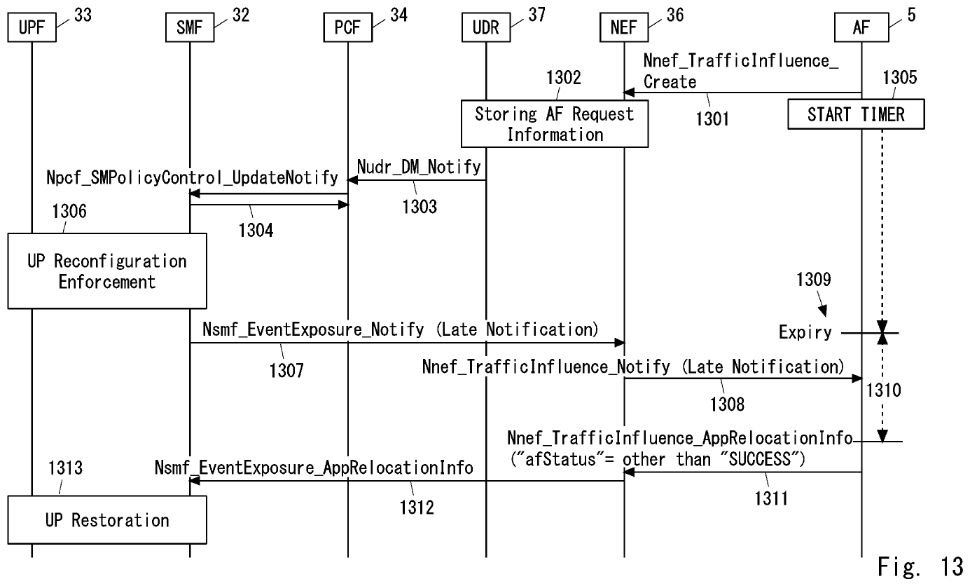

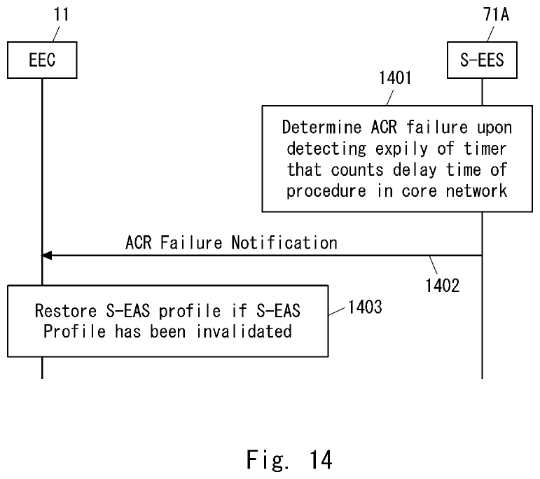

FIGS. 12 and 13 are sequence diagrams showing examples of the operation of the AF 5, SMF 32, UPF 33, PCF 34, NEF 36, and UDR 37. The AF 5 may include an S-EES or S-EAS. The examples shown in FIGS. 12 and 13 correspond to the third implementation described in the first example embodiment. That is, the AF 5 sends a first message (i.e., an AF request regarding AF influence on traffic routing) directly to the PCF 34 or through the NEF 36. The AF request relates to an event associated with the configuration of the UP path for a PDU Session. The event related to the configuration of the UP path for the PDU Session is the enforcement of the configuration of the UP path for the PDU Session.

The AF request requests the 3GPP core network 3 to reconfigure the UP path (e.g., change to the Target DNAI) for the traffic in an ongoing PDU Session of the UE 1. The AF request further includes a subscription request to late notification. Then, if the AF 5 receives a second message (i.e., late notification) after sending the AF request but before the expiration of the first predetermined period of time, the AF 5 sends a positive response to the late notification to the SMF 32 directly or through the NEF 36 (FIG. 12). Otherwise, the AF 5 sends a third message to the SMF 32 directly or through the NEF 36 indicating a failure of processing corresponding to the influence of the AF request, specifically a failure of processing in the AF 5 corresponding to the event related to the configuration of the UP path for the PDU Session (FIG. 13). The third message may be a negative response to the late notification.

FIG. 12 shows the case where the AF 5 receives a late notification based on the occurrence of an event related to the configuration of the UP path for the PDU Session before the first predetermined period of time expires, and the AF 5 sends a positive response to the late notification. In step 1201, the AF 5 sends an AF request to the NEF 36 by invoking the Nnef_TrafficInfluence_Create service operation. The AF request requests the 3GPP core network 3 to reconfigure the UP path (e.g., change to Target DNAI) for the traffic in the ongoing PDU Session of the UE 1. The Nnef_TrafficInfluence_Create may contain a notification reporting request for UP path change. In step 1202, the NEF 36 stores the information about the AF request in the UDR 37. In step 1203, the PCF 34 receives a Nudr_DM_Notify notification from the UDR 37 about the data change. Instead of steps 1201-1203, the AF 5 may send the AF request directly to the PCF 34 via a direct interface with the PCF 34 (i.e., the N5 interface).

In step 1204, the PCF 34 determines whether an existing PDU Session may be affected by the AF request. Then, for that PDU Session, the PDF 34 updates the SMF 32 with the corresponding new PCC rules by invoking the Npcf_SMPolicyControl_UpdateNotify service operation. If the AF request contains a request for one or both of early notification and late notification for a UP path management event (e.g., DNAI change), the PCF 34 includes in the PCC rule the information required for the reporting of that event. Here, the PCC rule includes the information required for late notification of the event.

In step 1205, the AF 5 starts a timer to count the first predetermined period of time. For example, but not limited to, the AF 5 may start the timer after, upon, or in response to transmitting the AF request.

In step 1206, the SMF 32 performs an event related to the configuration of the UP path for the PDU Session. Specifically, the SMF 32 exchanges control messages with the UPF 33 to enforce the user plane (UP) reconfiguration. The SMF 32 relocates or adds a PSA to configure a new UP path to the Target DNAI. Relocating or adding a PSA involves one or any combination of the addition, modification, and removal of one or more UPFs. However, before the UP path to the new DNAI is activated, the application traffic data continues to be routed to the old DNAI.

In step 1207, if late notification via the NEF has been requested by the AF 5, the SMF 32 notifies the NEF 36 of the Target DNAI by calling the Nsmf_EventExposure_Notify service operation. In step 1208, the NEF 36 performs information mapping and triggers the appropriate Nnef_TrafficInfluence_Notify message. If late direct notification has been requested by the AF 5, then instead of steps 1207 and 1208, the SMF 32 notifies the AF 5 of the Target DNAI by invoking the Nsmf_EventExposure_Notify service operation. The subscription request to the late (direct) notification contains the indication “AF acknowledgment to be expected”. According to this indication, the SMF 32 waits for a response from the AF 5 before the SMF 32 activates the new UP path. The SMF 32 does not activate the new UP path (e.g., the UP path to the new DNAI) until it receives a positive AF response to the late (direct) notification.

In step 1209, the AF 5 stops the timer in response to receiving a late notification before the timer expires. The late notification is based on the occurrence of an event related to the configuration of the UP path for the PDU Session. In step 1210, the AF 5 sends a positive response to the late notification to the NEF 36. Specifically, the AF 5 responds to the Nnef_TrafficInfluence_Notify by invoking the Nnef_TrafficInfluence_AppRelocationInfo service operation. The AF 5 may immediately invoke the Nnef_TrafficInfluence_AppRelocationInfo service operation. Alternatively, the AF 5 may call the Nnef_TrafficInfluence_AppRelocationInfo service operation after the application layer is ready or after any required application relocation to the Target DNAI is completed. The AF 5 includes in the payload of the HTTP POST message an AfAckInfo data type that contains an “afStatus” attribute set to “SUCCESS”. This indicates a positive response to the late notification.

In step 1211, the NEF 36 triggers an appropriate Nsmf_EventExposure_AppRelocationInfo in response to the receipt of the Nnef_TrafficInfluence_AppRelocationInfo. If the AF 5 receives a late (direct) notification, instead of steps 1210 and 1211, the AF 5 may invoke the Nsmf_EventExposure_AppRelocationInfo service operation to respond to the Nsmf_EventExposure_Notify.

In step 1212, the SMF 32 exchanges control messages with the UPF 33 to activate the UP reconfiguration (UP Reconfiguration Activation). In other words, the SMF 32 activates the UP path to the new DNAI. The relevant application traffic data is then routed to the new DNAI.

FIG. 13 shows the case where the first predetermined period of time expires before the AF 5 receives the late notification. Steps 1301-1308 in FIG. 13 are similar to steps 1201-1208 in FIG. 12. However, in the case of FIG. 13, the AF 5 receives a late notification (1308) during a graceful period (1310) after the timer expires (1309). Upon the expiration (1309) of the timer, the AF 5 may determine that the process being performed in the AF 5 has failed due to delays in the 3GPP core network 3.

In step 1311, in response to receiving the late notification after the timer expires, the AF 5 sends a negative response to the late notification to the NEF 36. Specifically, the AF 5 replies to the Nnef_TrafficInfluence_Notify by calling the Nnef_TrafficInfluence_AppRelocationInfo service operation. The AF 5 may immediately invoke the Nnef_TrafficInfluence_AppRelocationInfo service operation. Alternatively, the AF 5 may invoke the Nnef_TrafficInfluence_AppRelocationInfo service operation after the cancellation of the application relocation has been completed.

The AF 5 includes in the payload of the HTTP POST message (step 1311) an AfAckInfo data type that contains an “afStatus” attribute set to a value other than “SUCCESS”. This indicates a negative response to the late notification. The “afStatus” attribute set to a value other than “SUCCESS” indicates a failure cause. The value other than “SUCCESS” may be “TEMP_CONGESTION”, “RELOC_NO_ALLOWED”, or “OTHER”. The value “TEMP_CONGESTION” indicates that the application relocation fails due to temporary congestion. The value “RELOC_NO_ALLOWED” indicates that the application relocation fails because the application relocation is not allowed. The value “OTHER” indicates that the application relocation fails due to other reasons. Alternatively, the “afStatus” attribute may explicitly indicate that the processing corresponding to the influence of the AF request has failed due to processing delays in the 3GPP core network. Additionally or alternatively, the “afStatus” attribute may explicitly indicate that the application relocation process has failed based on the expiration of the timer for managing the process in the 3GPP core network. For example, the AF 5 may include in the payload of the HTTP POST message (step 1311) an AfAckInfo data type containing an “afStatus” attribute set to a value of “Failure_because_5GC_delay” or “RELOC_TIMER EXPIRED”.

In step 1312, the NEF 36 triggers the appropriate Nsmf_EventExposure_AppRelocationInfo in response to receiving the Nnef_TrafficInfluence_AppRelocationInfo. If the AF 5 has received a late direct notification, then instead of steps 1311 and 1312, the AF 5 may invoke the Nsmf_EventExposure_AppRelocationInfo service operation to respond to the Nsmf_EventExposure_Notify.

In step 1313, the SMF 32 exchanges control messages with the UPF 33 to restore the UP path to the original DNAI. Alternatively, the SMF 32 disables the configuration of the UP path to the new DNAI. The SMF 32 continues using the UP path to the original DNAI and cancels the change to the UP path to the new DNAI.

In the procedure shown in FIG. 13, if the graceful period (1310) has elapsed before the AF 5 receives the late notification, the AF 5 may, after, or depending on, or in response to, the elapse of the graceful period, send a message (e.g., a negative response to the late notification) indicating a failure in the processing corresponding to the influence of the AF request. The procedure shown in FIG. 13 may not have the graceful period (1310). In this case, if the timer expires (or the first predetermined period of time elapses) before the AF 5 receives the late notification, the AF 5 may send a message (e.g., a negative response to the late notification) indicating a failure in the processing corresponding to the influence of the AF request.

According to the procedure described in this example embodiment, if the AF 5 has not received a late notification from the 3GPP core network 3 by the expiration of the first predetermined period of time after sending an AF request, the AF 5 can determine that the procedure (e.g., UPF relocation or addition) in the 3GPP core network 3 regarding the AF influence on traffic routing is delayed, and can cancel this procedure. This allows the AF 5 to deal with the delay of the procedure in the 3GPP core network 3 regarding the AF influence on traffic routing.

### Fifth Example Embodiment

This example embodiment provides a detailed example of the operation of the AF5 described in the first example embodiment, as well as a detailed example of the operation of the UE1. The example network architecture according to this example embodiment is similar to the examples described with reference to FIGS. 1 to 5.

The AF 5 in this embodiment includes an S-EES 71A or an S-EAS 72A or both. If the AF 5 fails to receive a second message from the 3GPP core network 3 by the expiration of a first predetermined period of time after the AF 5 sends a first message to the 3GPP core network 3, the AF 5 determines that a procedure (e.g., UPF relocation or addition procedure) within the 3GPP core network 3 related to AF influence on traffic routing has been delayed and cancels the ACR procedure. The cancellation of the ACR procedure involves the AC 12 of the UE 1 continuing to use the S-EAS 72A. To enable this, if the AF 5 includes the S-EES 71A, the S-EES 71A sends an indication of the failure of the ACR procedure to the EEC 11 of the UE 1 if it fails to receive the second message from the 3GPP core network 3 before the expiration of the first predetermined period of time. The failure of the ACR procedure is due to a delay in the procedure (e.g., UPF relocation or addition) within the 3GPP core network 3 regarding AF influence on traffic routing. Accordingly, the indication of the failure of the ACR procedure may explicitly indicate that the failure is due to a delay in the procedure (e.g., UPF reallocation or addition) within the 3GPP core network 3. If the AF 5 contains the S-EAS 72A, the S-EAS 72A requests the S-EES 71A to send the indication of the failure of the ACR procedure to the EEC 11 of the UE 1 if it fails to receive the second message from the 3GPP core network 3 before the expiration of the first predetermined period of time. Upon receipt of such indication, the EEC 11 of the UE 1 restores (or activates) the profile of the S-EAS 72A, if this profile has been invalidated.

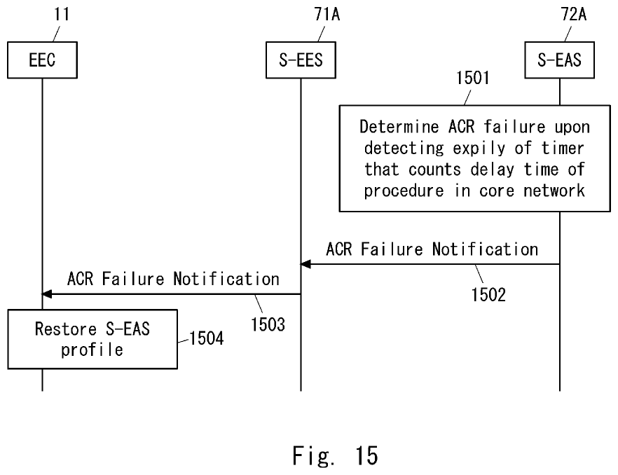

FIG. 14 shows an example of the operation of the AF 5 and the EEC 11 when the AF 5 includes the S-EES 71A. In step 1401, the AF 5 or the S-EES 71A included in the AF 5 detects the expiration of a timer counting the first predetermined period of time. The timer counts the delay time of the procedure in the 3GPP core network 3 related to AF influence on traffic routing. The first predetermined period of time can be considered the maximum allowable delay time. When the timer expires, the AF 5 or the S-EES 71A included in the AF 5 detects an ACR failure due to a delay in the procedure (e.g., UPF relocation or addition) in the 3GPP core network 3 regarding AF influence on traffic routing. In step 1402, after, upon, or in response to the timer expiration, the S-EES 71A sends to the EEC 11 of the UE 1 an ACR failure notification due to a delay in the procedure (e.g., UPF relocation or addition) in the 3GPP core network 3 regarding AF influence on traffic routing. The ACR failure notification explicitly or implicitly indicates a failure of the ongoing ACR procedure. The ACR failure notification may include a failure cause indicating that the failure was caused by a delay in a procedure (e.g., UPF relocation or addition) within the 3GPP core network 3 related to AF influence on traffic routing. In step 1403, in response to receiving the ACR failure notification, the EEC 11 restores (or activates) the profile of the S-EAS 72A, if this profile has been invalidated.

FIG. 15 shows an example of the operation of the AF 5 and the EEC 11 when the AF 5 includes the S-EAS 72A. In step 1501, the AF 5 or the S-EAS 72A included in the AF 5 detects the expiration of a timer counting the first predetermined period of time. The timer counts the delay time of the procedure in the 3GPP core network 3 related to AF influence on traffic routing. The first predetermined period of time can be considered the maximum allowable delay time. When the timer expires, the AF 5 or the S-EAS 72A included in the AF 5 detects an ACR failure due to a delay in the procedure (e.g., UPF relocation or addition) in the 3GPP core network 3 regarding AF influence on traffic routing. In step 1502, after, upon, or in response to the timer expiration, the S-EAS 72A sends an ACR failure notification to the S-EES 71A. The ACR failure notification explicitly or implicitly indicates a failure of the ongoing ACR procedure. The ACR failure notification may include a failure cause indicating that the failure was caused by a delay in a procedure (e.g., UPF relocation or addition) within the 3GPP core network 3 related to AF influence on traffic routing. In step 1503, the S-EES 71A sends an ACR failure notification to the EEC 11 of the UE 1. In step 1504, in response to receiving the ACR failure notification, the EEC 11 restores (or activates) the profile of the S-EAS 72A, if the profile has been invalidated. The ACR failure notification may include a failure cause indicating that the failure was caused by a delay in a procedure (e.g., UPF relocation or addition) within the 3GPP core network 3 related to AF influence on traffic routing.

The ACR procedure to be cancelled in the procedure of FIG. 14 or 15 may be, for example, any of the multiple ACR procedures described in Section 8.8.2 of Non-Patent Literature 3. The first predetermined period of time may be determined based on service continuity requirements of the application.

In the case of the “ACR initiated by the EEC and ACs” procedure (or scenario) described in Section 8.2.2.2 of Non-Patent Literature 3, the AF 5 (e.g., S-EES) may start the timer to count the first predetermined period in parallel with or before Step 3 (“T-EAS Discovery”) or in parallel with or before Step 5 (“ACR Request”).

In the case of the “EEC executed ACR via S-EES” procedure (or scenario) described in Section 8.2.2.3 of Non-Patent Literature 3, the AF 5 (e.g., S-EES) may start the timer to count the first predetermined period in parallel with or before Step 3 (“T-EAS Discovery”) or in parallel with or before Step 4 (“ACR Request”).

In the case of the “S-EAS decided ACR” procedure (or scenario) described in Section 8.2.2.4 of Non-Patent Literature 3, the AF 5 (e.g., S-EES or S-EAS) may start the timer to count the first predetermined period in parallel with or before Step 2 (“ACR Detection”), or in parallel with or before Step 3 (“T-EAS Discovery”).

In the case of the “S-EES executed ACR” procedure described in Section 8.2.2.5 of Non-Patent Literature 3, the AF 5 (e.g., S-EES) may start the timer to count the first predetermined period in parallel with or before Step 2 (“(ACR) Detection”), in parallel with or before Step 4 (“Decision of ACR”), or in parallel with or before Step 7 (“initiate application traffic influence”).

In the case of the “EEC executed ACR via T-EES” procedure (or scenario) described in Section 8.2.2.6 of Non-Patent Literature 3, the AF 5 (e.g., S-EES) may start the timer to count the first predetermined period in parallel with or before Step2 (“ACR Decision”), in parallel with or before Step 3 (“T-EAS Discovery”), or in parallel with or before Step 4 (“ACR Request”).

According to the operation of the AF 5 and UE 1 described in this example embodiment, if the AF 5 does not receive the second message from the 3GPP core network 3 by the expiration of the first predetermined period of time, the AF 5 can determine that the procedure in the 3GPP core network 3 regarding AF influence on traffic routing (e.g., UPF relocation or addition) has been delayed and cancel this procedure, and cancel the ongoing ACR procedure.

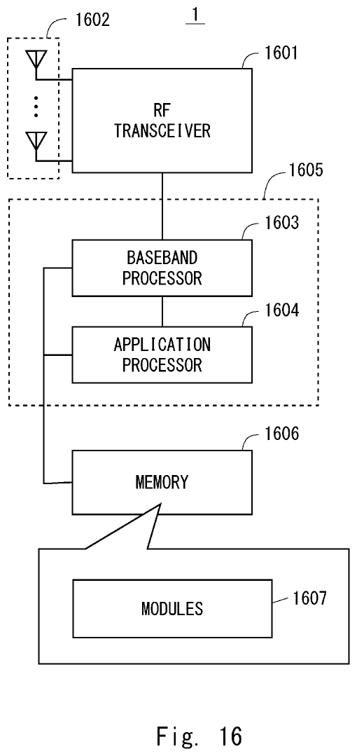

The following provides configuration examples of the UE 1 and AF 5 according to the above-described example embodiments. FIG. 16 is a block diagram showing an example configuration of the UE 1. A Radio Frequency (RF) transceiver 1601 performs analog RF signal processing to communicate with RAN nodes. The RF transceiver 1601 may include a plurality of transceivers. The analog RF signal processing performed by the RF transceiver 1601 includes frequency up-conversion, frequency down-conversion, and amplification. The RF transceiver 1601 is coupled to an antenna array 1602 and a baseband processor 1603. The RF transceiver 1601 receives modulated symbol data (or OFDM symbol data) from the baseband processor 1603, generates a transmission RF signal, and supplies the transmission RF signal to the antenna array 1602. Further, the RF transceiver 1601 generates a baseband reception signal based on a reception RF signal received by the antenna array 1602 and supplies the baseband reception signal to the baseband processor 1603. The RF transceiver 1601 may include an analog beamformer circuit for beam forming. The analog beamformer circuit includes, for example, a plurality of phase shifters and a plurality of power amplifiers.

The baseband processor 1603 performs digital baseband signal processing (i.e., data-plane processing) and control-plane processing for radio communication. The digital baseband signal processing includes (a) data compression/decompression, (b) data segmentation/concatenation, (c) composition/decomposition of a transmission format (i.e., transmission frame) (d) channel coding/decoding, (e) modulation (i.e., symbol mapping)/demodulation, and (f) generation of OFDM symbol data (i.e., baseband OFDM signal) by Inverse Fast Fourier Transform (IFFT). Meanwhile, the control-plane processing includes communication management of layer 1 (e.g., transmission power control), layer 2 (e.g., radio resource management and hybrid automatic repeat request (HARQ) processing), and layer 3 (e.g., signaling regarding attach, mobility, and call management).

The digital baseband signal processing by the baseband processor 1603 may include, for example, signal processing of Service Data Adaptation Protocol (SDAP), Packet Data Convergence Protocol (PDCP), Radio Link Control (RLC), Medium Access Control (MAC), and Physical (PHY) layers. The control-plane processing performed by the baseband processor 1603 may include processing of Non-Access Stratum (NAS) protocols, Radio Resource Control (RRC) protocols, MAC Control Elements (CEs), and Downlink Control Information (DCIs).

The baseband processor 1603 may perform Multiple Input Multiple Output (MIMO) encoding and pre-coding for beam forming.

The baseband processor 1603 may include a modem processor (e.g., Digital Signal Processor (DSP)) that performs the digital baseband signal processing and a protocol stack processor (e.g., a Central Processing Unit (CPU) or a Micro Processing Unit (MPU)) that performs the control-plane processing. In this case, the protocol stack processor, which performs the control-plane processing, may be integrated with an application processor 1604 described below.

The application processor 1604 is also referred to as a CPU, an MPU, a microprocessor, or a processor core. The application processor 1604 may include a plurality of processors (or processor cores). The application processor 1604 loads a system software program (Operating System (OS)) and various application programs (e.g., a call application, a WEB browser, a mailer, a camera operation application, and a music player application) from a memory 1606 or from another memory not shown and executes these programs, thereby providing various functions of the UE 1.

In some implementations, as represented by a dashed line (1605) in FIG. 16, the baseband processor 1603 and the application processor 1604 may be integrated on a single chip. In other words, the baseband processor 1603 and the application processor 1604 may be implemented in a single System on Chip (SoC) device 1605. The SoC device may be referred to as a Large-Scale Integration (LSI) or a chipset.

The memory 1606 is a volatile memory, a non-volatile memory, or a combination thereof. The memory 1606 may include a plurality of memory devices that are physically independent from each other. The volatile memory is, for example, a Static Random Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 1606 may include, for example, an external memory device that can be accessed from the baseband processor 1603, the application processor 1604, and the SoC 1605. The memory 1606 may include an internal memory device that is integrated in the baseband processor 1603, the application processor 1604, or the SoC 1605. Further, the memory 1606 may include a memory in a Universal Integrated Circuit Card (UICC).

The memory 1606 may store one or more software modules (computer programs) 1607 including instructions and data to perform the processing by the UE 1 described in the above example embodiments. In some implementations, the baseband processor 1603 or the application processor 1604 may load these software modules 1607 from the memory 1606 and execute the loaded software modules, thereby performing the processing of the UE 1 described in the above example embodiments with reference to the drawings.

The control-plane processing and operations performed by the UE 1 described in the above example embodiments can be achieved by elements other than the RF transceiver 1601 and the antenna array 1602, i.e., achieved by the memory 1606, which stores the software modules 1607, and one or both of the baseband processor 1603 and the application processor 1604.

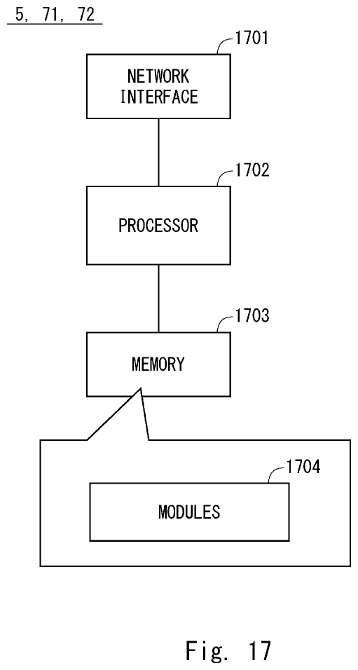

FIG. 17 shows an example configuration of an apparatus providing the functions of the AF 5. Other apparatuses providing network functions, such as the AMF 31, SMF 32, NEF 36, ECS 6, EES 71, EAS 72, etc., may have similar configurations to those shown in FIG. 17. Referring to FIG. 17, the AF 5 (or EES 71, or EAS 72) includes a network interface 1701, a processor 1702, and a memory 1703. The network interface 1701 is used to communicate with other network functions (NFs) or nodes. The network interface 1701 may include, for example, a network interface card (NIC) conforming to the IEEE 802.3 series.

The processor 1702 may be, for example, a microprocessor, a Micro Processing Unit (MPU), or a Central Processing Unit (CPU). The processor 1702 may include a plurality of processors.

The memory 1703 is composed of a volatile memory and a nonvolatile memory. The volatile memory is, for example, a Static Random Access Memory (SRAM), a Dynamic RAM (DRAM), or a combination thereof. The non-volatile memory is, for example, a Mask Read Only Memory (MROM), an Electrically Erasable Programmable ROM (EEPROM), a flash memory, a hard disc drive, or any combination thereof. The memory 1703 may include a storage located apart from the processor 1702. In this case, the processor 1702 may access the memory 1703 via the network interface 1701 or an I/O interface not shown.

The memory 1703 may store one or more software modules (computer programs) 1704 including instructions and data to perform the processing of the AF 5 (or EES 71, or EAS 72) described in the above example embodiments. In some implementations, the processor 1702 may be configured to load the one or more software modules 1704 from the memory 1703 and execute the loaded software modules, thereby performing the processing of the AF 5 (or EES 71, or EAS 72) described in the above example embodiments.

As described using FIGS. 16 and 17, each of the processors in the UE 1, AF 5 (or EES 71, or EAS 72), and other network functions according to the example embodiments described above executes one or more programs, containing a set of instructions, to cause a computer to perform an algorithm described with reference to the drawings.

Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The above-described example embodiments are merely examples of applications of the technical ideas obtained by the inventors. These technical ideas are not limited to the above-described example embodiments and various modifications can be made thereto.

The whole or part of the example embodiments disclosed above can be described as, but not limited to, the following supplementary notes.

### Supplementary Note 1

An Application Function (AF) node comprising:
a memory; and
at least one processor coupled to the memory and configured to:
   send to a core network a first message regarding an event related to a configuration of a user plane path for a Protocol Data Unit (PDU) Session;
   if the AF node receives a second message based on an occurrence of the event from the core network before a first predetermined period of time expires after the transmission of the first message, send a positive response to the second message to the core network; and
   if the AF node does not receive the second message from the core network before the expiration of the first predetermined period of time, send to the core network a third message indicating a failure of a process in the AF node corresponding to the event.

### Supplementary Note 2

The AF node according to Supplementary Note 1, wherein the at least one processor is configured to determine that the event has failed if the second message is not received from the core network before the expiration of the first predetermined period of time.

### Supplementary Note 3

The AF node according to Supplementary Note 1 or 2, wherein the at least one processor is configured to start a timer to count the first predetermined period of time in response to the transmission of the first message.

### Supplementary Note 4

The AF node according to any one of Supplementary Notes 1 to 3, wherein the at least one processor is configured to send the third message in response to the AF node receiving the second message during a second predetermined period of time after the expiration of the first predetermined period of time.

### Supplementary Note 5

The AF node according to any one of Supplementary Notes 1 to 4, wherein
the core network includes a Session Management Function (SMF) node, a Policy Control Function (PCF) node, and a Network Exposure Function (NEF) node, and
the at least one processor is configured to:
   send the first message to the SMF node, either directly or via one or both of the NEF node and the PCF node;
   receive the second message from the SMF node, either directly or via the NEF node; and
   send the positive response to the second message, or the third message to the SMF node, either directly or via the NEF node.

### Supplementary Note 6

The AF node according to Supplementary Note 5, wherein
the event is enforcement of the configuration of the user plane path for the PDU Session,
the at least one processor is configured to receive a first notification, which is a prior notification of the event, from the SMF node before the first message is sent,
the first message includes a positive response to the first notification, and
the second message is sent by the SMF node after the event is completed and before the user plane path is activated.

### Supplementary Note 7

The AF node according to Supplementary Note 5, wherein
the event is enforcement of the configuration of the user plane path for the PDU Session,
the first message includes a request to the SMF node to cause the event, and
the second message is a prior notification of the event.

### Supplementary Note 8

The AF node according to Supplementary Note 5, wherein
the event is enforcement of the configuration of the user plane path for the PDU Session,
the first message includes a request to the SMF node to cause the event, and
the second message is sent by the SMF node after the event is completed and before the user plane path is activated.

### Supplementary Note 9

The AF node according to Supplementary Note 5, wherein
the second message is related to a change from an original user plane path to a new user plane path for traffic of the PDU Session, and
the third message causes the SMF node to continue using the original user plane path and to cancel the change from the original user plane path to the new user plane path.

### Supplementary Note 10

The AF node according to Supplementary Note 9, wherein the second message is related to a Data Network Access Identifier (DNAI) change and is sent by the SMF node prior to configuring or activating the new user plane path to a new DNAI.

### Supplementary Note 11

The AF node according to any one of Supplementary Notes 1 to 10, wherein
the AF node includes a Source Edge Enabler Server (S-EES), and
the at least one processor is configured to send an indication of failure of an Application Context Relocation (ACR) procedure involving transfer of an application context from a Source Edge Application Server (S-EAS) to a Target EAS (T-EAS) if the second message is not received from the core network before the first predetermined period of time has expired.

### Supplementary Note 12

The AF node according to any one of Supplementary Notes 1 to 10, wherein
the AF node includes a Source Edge Application Server (S-EAS), and
the at least one processor is configured to, if the second message is not received from the core network before the first predetermined period of time has expired, request a Source Edge Enabler Server (S-EES) to send to an Edge Enabler Client (EEC) of a User Equipment (UE) an indication of failure of an Application

Context Relocation (ACR) procedure involving transfer of an application context from the S-EAS to a Target EAS (T-EAS).

### Supplementary Note 13

A method performed by an Application Function (AF) node, the method comprising:
sending to a core network a first message regarding an event related to a configuration of a user plane path for a Protocol Data Unit (PDU) Session;
if the AF node receives a second message based on an occurrence of the event from the core network before a first predetermined period of time expires after the transmission of the first message, sending a positive response to the second message to the core network; and
if the AF node does not receive the second message from the core network before the expiration of the first predetermined period of time, sending to the core network a third message indicating a failure of a process in the AF node corresponding to the event.

### Supplementary Note 14

A program for causing a computer to perform a method for an Application Function (AF) node, the method comprising:
sending to a core network a first message regarding an event related to a configuration of a user plane path for a Protocol Data Unit (PDU) Session;
if the AF node receives a second message based on an occurrence of the event from the core network before a first predetermined period of time expires after the transmission of the first message, sending a positive response to the second message to the core network; and
if the AF node does not receive the second message from the core network before the expiration of the first predetermined period of time, sending to the core network a third message indicating a failure of a process in the AF node corresponding to the event.

### Supplementary Note 15

A User Equipment (UE) comprising:
a memory; and
at least one processor coupled to the memory and configured to:
   provide Edge Enabler Client (EEC) functionality;
   receive, from a Source Edge Enabler Server (S-EES), an indication of a failure of an Application Context Relocation (ACR) procedure involving transfer of an application context from a Source Edge Application Server (S-EAS) to a Target EAS (T-EAS); and
   if a profile of the S-EAS has been invalidated, activate the profile of the S-EAS in response to receiving the indication,
wherein the failure of the ACR procedure is due to a delay in configuring a user plane path for a Protocol Data Unit (PDU) Session.

### Supplementary Note 16

A method performed by a User Equipment (UE), the method comprising:
providing Edge Enabler Client (EEC) functionality;
receiving, from a Source Edge Enabler Server (S-EES), an indication of a failure of an Application Context Relocation (ACR) procedure involving transfer of an application context from a Source Edge Application Server (S-EAS) to a Target EAS (T-EAS); and
if a profile of the S-EAS has been invalidated, activating the profile of the S-EAS in response to receiving the indication,
wherein the failure of the ACR procedure is due to a delay in configuring a user plane path for a Protocol Data Unit (PDU) Session.

### Supplementary Note 17

A program for causing a computer to perform a method for a User Equipment (UE), the method comprising:
providing Edge Enabler Client (EEC) functionality;
receiving, from a Source Edge Enabler Server (S-EES), an indication of a failure of an Application Context Relocation (ACR) procedure involving transfer of an application context from a Source Edge Application Server (S-EAS) to a Target EAS (T-EAS); and
if a profile of the S-EAS has been invalidated, activating the profile of the S-EAS in response to receiving the indication,
wherein the failure of the ACR procedure is due to a delay in configuring a user plane path for a Protocol Data Unit (PDU) Session.

This application is based upon and claims the benefit of priority from Japanese Patent Application No. 2021-084222, filed on May 18, 2021, the disclosure of which is incorporated herein in its entirety by reference.

### REFERENCE SIGNS LIST

1 User Equipment (UE)
2 Access Network (AN)
3 3GPP Coe Network
5 Application Function (AF)
6 Edge Configuration Server (ECS)
7 Edge Data Network (EDN)
8 Public Land Mobile Network (PLMN)
11 Edge Enabler Client (EEC)
12 Application client (AC)
31 Access and Mobility management Function (AMF)
32 Session Management Function (SMF)
33 User Plane Function (UPF)
34 Policy Control Function (PCF)
35 Unified Data Management (UDM)
36 Network Exposure Function (NEF)
41, 42, 43 Data Network (DN)
71 Edge Enabler Server (EES)
72 Edge Application Server (EAS)
1603 Baseband Processor
1604 Application Processor
1606 Memory
1607 Modules
1702 Processor
1703 Memory
1704 Modules

What is claimed is:

1. An Application Function (AF) node comprising:
a memory; and
at least one processor coupled to the memory and configured to:
send to a core network a first message regarding an event related to a configuration of a user plane path for a Protocol Data Unit (PDU) Session;
if the AF node receives a second message based on an occurrence of the event from the core network before a first predetermined period of time expires after the transmission of the first message, send a positive response to the second message to the core network; and
if the AF node does not receive the second message from the core network before the expiration of the first predetermined period of time, send to the core network a third message indicating a failure of a process in the AF node corresponding to the event.

2. The AF node according to claim 1, wherein the at least one processor is configured to determine that the event has failed if the second message is not received from the core network before the expiration of the first predetermined period of time.

3. The AF node according to claim 1, wherein the at least one processor is configured to start a timer to count the first predetermined period of time in response to the transmission of the first message.

4. The AF node according to claim 1, wherein the at least one processor is configured to send the third message in response to the AF node receiving the second message during a second predetermined period of time after the expiration of the first predetermined period of time.

5. The AF node according to claim 1, wherein
the core network includes a Session Management Function (SMF) node, a Policy Control Function (PCF) node, and a Network Exposure Function (NEF) node, and
the at least one processor is configured to:
send the first message to the SMF node, either directly or via one or both of the NEF node and the PCF node;
receive the second message from the SMF node, either directly or via the NEF node; and
send the positive response to the second message, or the third message to the SMF node, either directly or via the NEF node.

6. The AF node according to claim 5, wherein
the event is enforcement of the configuration of the user plane path for the PDU Session,
the at least one processor is configured to receive a first notification, which is a prior notification of the event, from the SMF node before the first message is sent,
the first message includes a positive response to the first notification, and
the second message is sent by the SMF node after the event is completed and before the user plane path is activated.

7. The AF node according to claim 5, wherein
the event is enforcement of the configuration of the user plane path for the PDU Session,
the first message includes a request to the SMF node to cause the event, and
the second message is a prior notification of the event.

8. The AF node according to claim 5, wherein
the event is enforcement of the configuration of the user plane path for the PDU Session,
the first message includes a request to the SMF node to cause the event, and
the second message is sent by the SMF node after the event is completed and before the user plane path is activated.

9. The AF node according to claim 5, wherein
the second message is related to a change from an original user plane path to a new user plane path for traffic of the PDU Session, and
the third message causes the SMF node to continue using the original user plane path and to cancel the change from the original user plane path to the new user plane path.

10. The AF node according to claim 9, wherein the second message is related to a Data Network Access Identifier (DNAI) change and is sent by the SMF node prior to configuring or activating the new user plane path to a new DNAI.

11. The AF node according to claim 1, wherein
the AF node includes a Source Edge Enabler Server (S-EES), and
the at least one processor is configured to send an indication of failure of an Application Context Relocation (ACR) procedure involving transfer of an application context from a Source Edge Application Server (S-EAS) to a Target EAS (T-EAS) if the second message is not received from the core network before the first predetermined period of time has expired.

12. The AF node according to claim 1, any one of claims 1 to 10, wherein
the AF node includes a Source Edge Application Server (S-EAS), and
the at least one processor is configured to, if the second message is not received from the core network before the first predetermined period of time has expired, request a Source Edge Enabler Server (S-EES) to send to an Edge Enabler Client (EEC) of a User Equipment (UE) an indication of failure of an Application Context Relocation (ACR) procedure involving transfer of an application context from the S-EAS to a Target EAS (T-EAS).

13. A method performed by an Application Function (AF) node, the method comprising:
sending to a core network a first message regarding an event related to a configuration of a user plane path for a Protocol Data Unit (PDU) Session;
if the AF node receives a second message based on an occurrence of the event from the core network before a first predetermined period of time expires after the transmission of the first message, sending a positive response to the second message to the core network; and
if the AF node does not receive the second message from the core network before the expiration of the first predetermined period of time, sending to the core network a third message indicating a failure of a process in the AF node corresponding to the event.

14. (canceled)

15. A User Equipment (UE) comprising:
a memory; and
at least one processor coupled to the memory and configured to:
provide Edge Enabler Client (EEC) functionality;
receive, from a Source Edge Enabler Server (S-EES), an indication of a failure of an Application Context Relocation (ACR) procedure involving transfer of an application context from a Source Edge Application Server (S-EAS) to a Target EAS (T-EAS); and
if a profile of the S-EAS has been invalidated, activate the profile of the S-EAS in response to receiving the indication,
wherein the failure of the ACR procedure is due to a delay in configuring a user plane path for a Protocol Data Unit (PDU) Session.

16. (canceled)

17. (canceled)
